(19) United States
(12) Patent Application Publication
(10) Pub. No.: US 2025/0200192 A1
(43) Pub. Date: Jun. 19, 2025

(54) SYSTEMS AND METHODS FOR ASSESSING THE VULNERABILITY OF CYBER-PHYSICAL SYSTEMS

(71) Applicant: The Florida State University Research Foundation, Inc., Tallahassee, FL (US)

(72) Inventors: Olugbenga Moses Anubi, Tallahassee, FL (US); Yu Zheng, Tallahassee, FL (US)

(21) Appl. No.: 18/916,202

(22) Filed: Oct. 15, 2024

Related U.S. Application Data
(60) Provisional application No. 63/609,587, filed on Dec. 13, 2023.

(51) Int. Cl. G06F 21/57

(52) U.S. Cl. CPC G06F 21/577

(57) ABSTRACT

Methods for securing cyber-physical systems include attack generation systems, methods, and devices configured to assess vulnerabilities of cyber-physical systems include an example method of training an attack generative model using an attack policy to generate an attack dataset, training discriminators using a random attack dataset and generated attack dataset and training a generator using the trained discriminators.

### CROSS-REFERENCE TO RELATED APPLICATIONS

This application claims the benefit of U.S. provisional patent application No. 63/609,587 filed on Dec. 13, 2023, and titled “SYSTEMS AND METHODS FOR ASSESSING THE VULNERABILITY OF CYBER-PHYSICAL SYSTEMS,” the disclosure of which is expressly incorporated herein by reference in its entirety.

### STATEMENT REGARDING FEDERALLY FUNDED RESEARCH

This invention was made with government support under Grant number DECR0000005 awarded by the Department of Energy. The government has certain rights in this invention.

### BACKGROUND

Industrial and infrastructure systems commonly include supervisory, control, and data acquisition (SCADA) systems. SCADA includes data collection, estimation, and/or decision processes for industrial facilities. SCADA systems are commonly implemented using networks that can include any number of computing devices, sensors, user controls, actuators, etc. SCADA networks can sometimes include internet access, and/or can cover large areas. As a result, SCADA systems can be difficult to secure, and can be significant vulnerabilities for industry and infrastructure installments. There are benefits to improving cybersecurity for such facilities, in particular the networks and devices used to monitor and/or operate infrastructure and industrial systems.

### SUMMARY

In some aspects, implementations of the present disclosure include a computer-implemented method of training a machine learning model, the method including: generating a random parameter vector; generating a random attack dataset; inputting a plurality of samples of the random attack dataset into a generator; generating, by the generator, a generated attack dataset; training a discriminator using the random attack dataset and the generated attack dataset; and training the generator using the trained discriminators and a loss function.

In some aspects, implementations of the present disclosure include a computer-implemented method, wherein the generated attack dataset includes an attack policy.

In some aspects, implementations of the present disclosure include a computer-implemented method, wherein the attack policy includes a ramp attack.

In some aspects, implementations of the present disclosure include a computer-implemented method, wherein the attack policy includes a sensor attack.

In some aspects, implementations of the present disclosure include a computer-implemented method, wherein the generator includes a deep neural network.

In some aspects, implementations of the present disclosure include a computer-implemented method, wherein the generator is trained with the loss function.

In some aspects, implementations of the present disclosure include a computer-implemented method for training a machine learning model, the method including: receiving a generative model parameter vector; generating sample points from a prior distribution of the generative model parameter vector; generating attack policy parameters simulating simulated attack policy parameters by a system simulation training a generative model by the simulated attack policy parameters.

In some aspects, implementations of the present disclosure include a computer-implemented method, wherein training the generative model includes a deep neural network

In some aspects, implementations of the present disclosure include a computer-implemented method, wherein training the generative model includes selecting a best loss value by.

In some aspects, implementations of the present disclosure include a computer-implemented method, wherein the attack policy parameters include a ramp attack policy.

In some aspects, implementations of the present disclosure include a computer-implemented method, wherein the attack policy parameters include a sine attack policy.

In some aspects, implementations of the present disclosure include a computer-implemented method, wherein the attack policy parameters include a pulse attack policy.

In some aspects, implementations of the present disclosure include a cybersecurity system including: a physical plant a network configured for communications and/or control of the physical plant; a cybersecurity controller operably connected to the network, wherein the cybersecurity controller includes a processor and memory with instructions stored thereon, that, when executed by the processor cause the processor to: receive a trained attack generative model; simulate, by the trained attack generative model, a plurality of attacks on the physical plant; determine an attack effectiveness of each of the plurality of attacks; and control access to the network based on the effectiveness of each of the plurality of attacks.

In some aspects, implementations of the present disclosure include a system, wherein the physical plant includes a networked pipeline system.

In some aspects, implementations of the present disclosure include a system, wherein the networked pipeline system includes a plurality of pressure sensors operably coupled to the network, and controlling access to the network includes securing at least one of the plurality of pressure sensors.

In some aspects, implementations of the present disclosure include a system, wherein the physical plant includes a power grid.

In some aspects, implementations of the present disclosure include a system, wherein the power grid includes a plurality of meters configured to measure the power and frequency of the power grid, and controlling access to the network includes securing at least one of the plurality of meters.

In some aspects, implementations of the present disclosure include a system, wherein the physical plant includes a cyber-physical system.

In some aspects, implementations of the present disclosure include a system, wherein the physical plant includes an industrial facility.

In some aspects, implementations of the present disclosure include a system, wherein the controller further contains instructions that cause the processor to simulate a vulnerability of the physical plant and control the physical plant based on the vulnerability.

In some aspects, implementations of the present disclosure include a system, wherein the controller is further configured to control the network device based on the sampled actions implemented on the system model.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a cybersecurity system, according to implementations of the present disclosure.

FIG. 2A illustrates a method of training a machine learning model to evaluate a vulnerability of a physical system, according to implementations of the present disclosure.

FIG. 2B illustrates a method of training a machine learning model to evaluate a vulnerability of a physical system, according to implementations of the present disclosure.

FIG. 3A illustrates an example implementation of the method of FIG. 2A.

FIG. 3B illustrates an example implementation of the method of FIG. 2B.

FIG. 4 illustrates an example computing device.

FIG. 5 illustrates a schematic diagram of SCADA for networked pipeline systems under adversarial attacks.

FIG. 6 illustrates a schematic description of an example implementation of a vulnerability analysis model, according to implementations of the present disclosure.

FIG. 7 illustrates a four-node pipeline network simulation platform used in a study of an example implementation of the present disclosure.

FIG. 8 illustrates an example of nominal control performance with disturbance injection between 100 s and 120 s.

FIG. 9 illustrates a study of an example implementation of an attack generator in a system simulation.

FIG. 10 illustrates loss curves of example discriminators at different training epochs in a study of an example implementation of the present disclosure.

FIG. 11 illustrates example control performance under generated attacks from a trained attack generator in a study of an example implementation of the present disclosure.

FIG. 12 illustrates an example BDD residual under generated attacks, in a study of an example implementation of the present disclosure

FIG. 13 illustrates an example control system of a networked cyber-physical system (NCPS) according to implementations of the present disclosure.

FIG. 14 illustrates an example training framework of an attack generative model with pre-defined attack policy and custom loss function, according to implementations of the present disclosure.

FIG. 15 illustrates example attack policies used in an example implementation of the present disclosure.

FIG. 16 illustrates a schematic description of a cyber-physical IEEE 14-bus system, according to an example implementation of the present disclosure.

FIG. 17 illustrates example performance of an attack generator with a ramp attack policy after each epoch.

FIG. 18 illustrates example performance of an attack generator with a sin attack policy after each epoch.

FIG. 19 illustrates example performance of an attack generator with a pulse attack policy after each epoch.

FIG. 20 illustrate example performance of generated attacks from trained attack generators with different attack policies, according to a study of an example implementation.

FIG. 21 illustrates a schematic description of a networked cyber-physical gas pipeline system.

FIG. 22 illustrates example gas pipeline topologies tested in a study of an example implementation of the present disclosure.

FIG. 23 illustrates a study of the performance of an attack generator with a ramp attack policy applied to a linear topological pipeline system in two epochs.

FIG. 24 illustrates a study of the performance of an attack generator with a ramp attack policy applied to a tree topological pipeline system in two epochs.

FIG. 25 illustrates a study of the performance of an attack generator with a ramp attack policy on the cyclic topological pipeline system in two epochs.

FIG. 26 illustrates the performance of a sample generative attack on a linear topological pipeline system.

FIG. 27 illustrates the performance of a sample generative attack on a tree topological pipeline system.

FIG. 28 illustrates the performance of a sample generative attack on a cyclic topological pipeline system.

FIG. 29 illustrates a table of results for a study of an example implementation of the present disclosure.

FIG. 30 shows the testing scores of the trained generators after batches in the first 2 epochs, according to a study of an example implementation of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for improving and/or analyzing vulnerabilities in industrial SCADA systems, it will become evident to those skilled in the art that the implementations are not limited thereto, but are applicable for improving the security of communications and control systems in general.

As used herein, the terms “about” or “approximately” when referring to a measurable value such as an amount, a percentage, and the like, is meant to encompass variations of ±20%, ±10%, ±5%, or ±1% from the measurable value.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

Deep learning models, including LLMs, may include artificial neural networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

Implementations of the present disclosure include improvements to the security of networked pipeline systems (NPS) and other infrastructure systems. Such systems broadly include “cyber physical systems” that can control the physical elements of a facility or infrastructure. The physical system can be referred to as a “physical plant” and can broadly include machinery, communications systems, networks, and controllers. One example type of infrastructure are networked pipeline systems (NPS) that can play an important role in transporting essential resources such as oil and gas. Increasing integration of information and control techniques in these systems can improve their performance, at the cost of increasing their vulnerability to cyber attacks. Such attacks can have severe consequences on the safety, security, and reliability of pipeline operations. Supervisory control and data acquisition (SCADA) can be used to operate NPS, and provide data collection, state estimation, and decision processes. But SCADA also introduces vulnerabilities. As one example, the state estimation process could be misled maliciously by compromising only a small portion of the IoT-based measurement system [3]. Modifying the control inputs at the automatic control layer can result in catastrophic consequences on physical assets [4].

In order to effectively design and operate security systems, it can be beneficial to model potential attack scenarios and model potential system responses. Such modeling can include generating modeled “attacks,” referred to herein as “attack generation.” Assessing the vulnerability of NPS is a challenging task, as it requires a thorough understanding of the complex interplay between the physical and cyber components of the system and the potential attack scenarios. Existing systems and methods for attack generation and modeling can fail to account for the nonlinear nature of many networked systems (e.g., pipeline systems) and/or require complex or difficult to acquire training data.

Implementations of the present disclosure include improvements to overcome limitations of existing systems for modeling attacks. An example implementation includes an attack generation framework that can integrate physical runtime data of a pipeline system and use a data-driven attack generation approach. The vulnerability analysis can be formulated as determining the presence of feasible attack sets, defined by boundary functions representing the effectiveness and stealthiness of attack signals with respect to the objective and attack detection module. The framework utilizes three data-driven models, including two discriminative models that learn the boundary functions and a generative model that produces elements of the feasible attack set. A loss function defined herein ensures successful attack generation with high probability.

While the implementations described herein are described with reference to industrial and infrastructure systems (e.g., pipelines) it should be understood that implementations of the present disclosure can be used to improve the security and/or operation of any system.

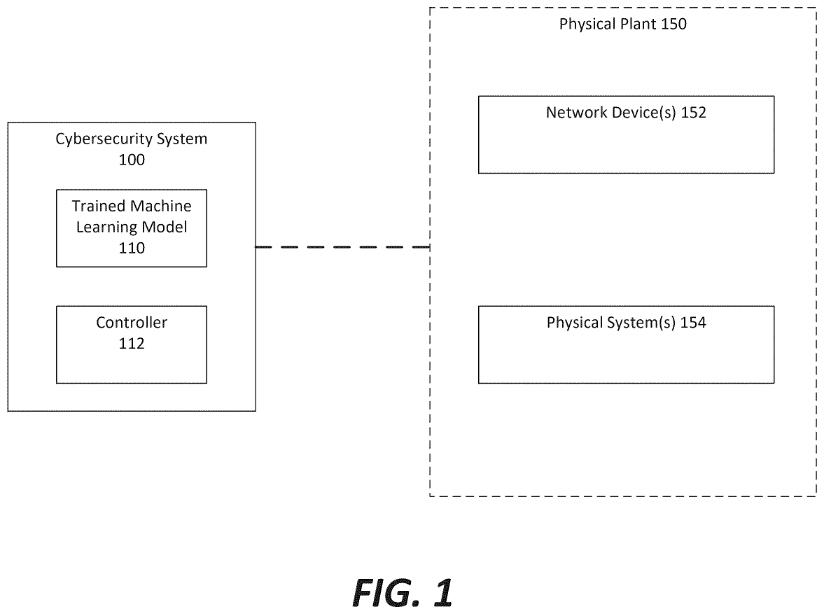

With reference to FIG. 1, an example cybersecurity system is shown according to implementations of the present disclosure. A cybersecurity system 100 can include a trained machine learning model 110 that is configured to assess vulnerabilities of a physical plant 150. The physical plant 150 can include any number of network devices 152 (e.g., computing devices, sensors, controllers, etc.) and any number of physical systems 154 (e.g., pumps, motors, actuators, etc.). The cybersecurity system 100 can use the trained machine learning model 110 to model the physical plant 150 and determine cybersecurity vulnerabilities of the network devices 152 and physical systems 154.

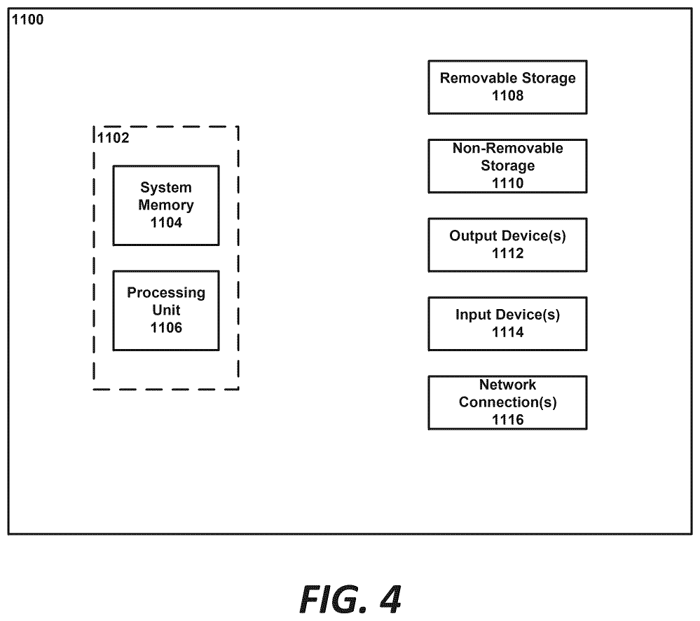

For example, the cybersecurity system 100 can include a controller 112 (e.g., a computing device 1100 as described with reference to FIG. 4). The controller 112 can be configured to receive a trained attack generative model, simulate, by the trained attack generative model, a plurality of attacks on the physical plant, determine an attack effectiveness of each of the plurality of attacks; and control access to the network based on the effectiveness of each of the plurality of attacks.

It should be understood that the physical plant 150 can be any physical system. For example, the physical plant 150 can be a networked pipeline system including pressure sensors, and the cybersecurity system 100 can be configured to secure the pipeline system by controlling access to the network devices 152, and/or securing parts of the physical systems 154 (e.g., securing one or more of the pressure sensors).

As another non-limiting example, the physical plant can include a power grid, and the physical systems 154 can include one or more meters configured to measure parameters of the power grid (e.g., voltage, frequency, current) at nodes in the power grid. Again, the cybersecurity system 100 can be used to model the vulnerabilities of the power grid, and can control access to the network devices 152 (e.g., meters) and/or physical systems 154 of the power grid to improve the security of the power grid.

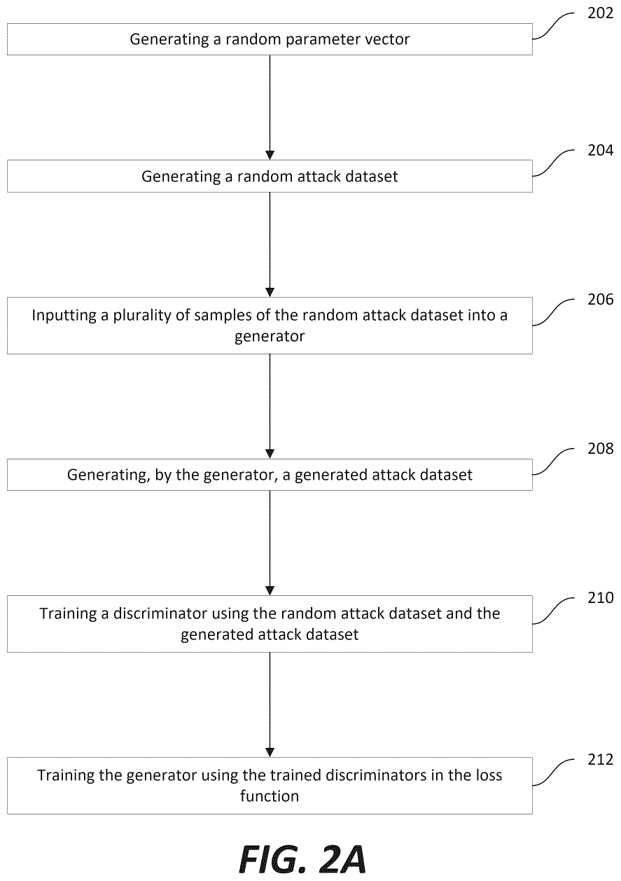

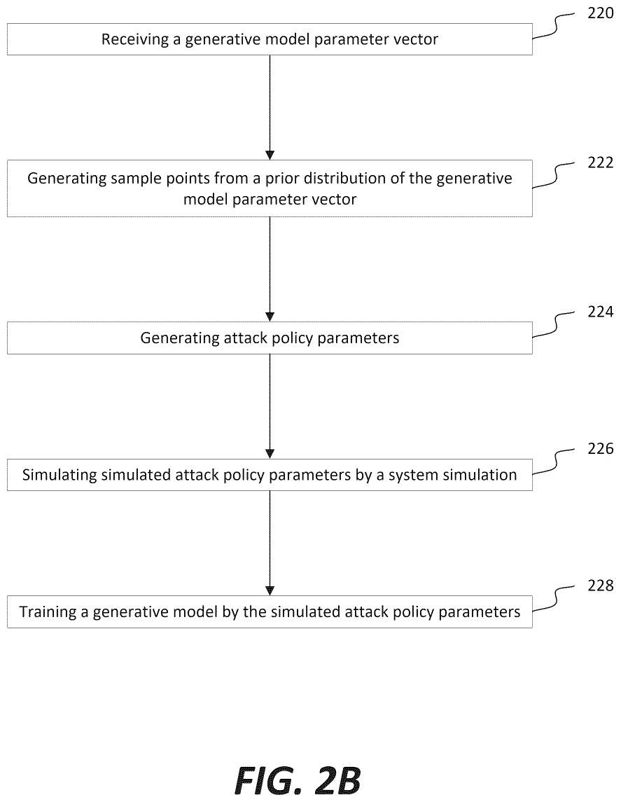

With reference to FIG. 2A, an example method is shown according to implementations of the present disclosure. The example method can be used to configure the cybersecurity system 100, for example by configuring the trained machine learning model 110 and/or controller 112.

At step 202 the method includes generating a random parameter vector.

At step 204 the method includes generating a random attack dataset.

At step 206 the method include inputting samples of the random attack dataset into a generator. Optionally the generator can be implemented as a deep neural network.

At step 208 the method includes generating a generated attack dataset using the generator. Optionally, the generated attack dataset can include an attack policy that describes the type(s) of attack that can be used. An example category of attack is an attack on one or more sensors of a physical system (e.g., by injecting false sensor data into a network). Non-limiting examples of this type of attack include ramp attacks, where false data is ramped up or down over time.

At step 210 the method includes training a discriminator using the random attack dataset and the generated attack dataset.

At step 212 the method includes training the generator using the trained discriminator and a loss function. An example loss function that can be used is:

$$L ( G ( z ; θ ) ) = ReLU ( {𝔼}_{z \sim {P}_{z}} [ D ( G ( z ; θ ) ) ] - ( 1 - α ) ) .$$

Additional description of loss functions is provided with reference to Example 1, hereto.

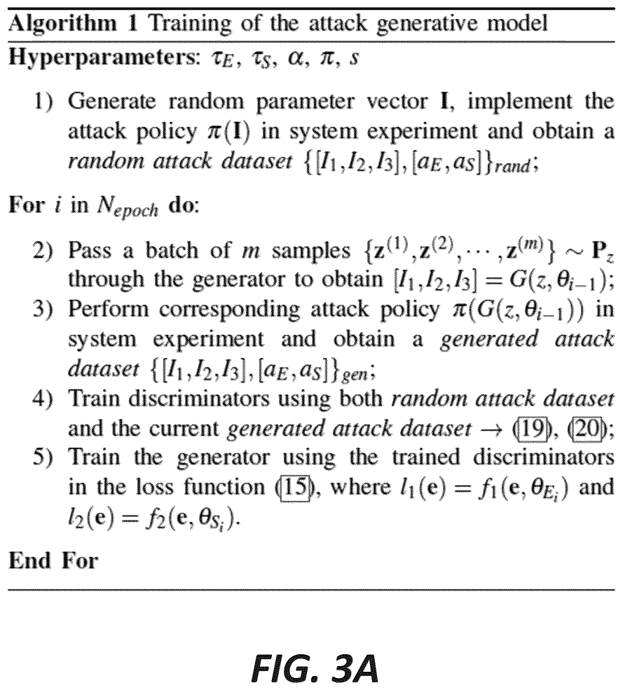

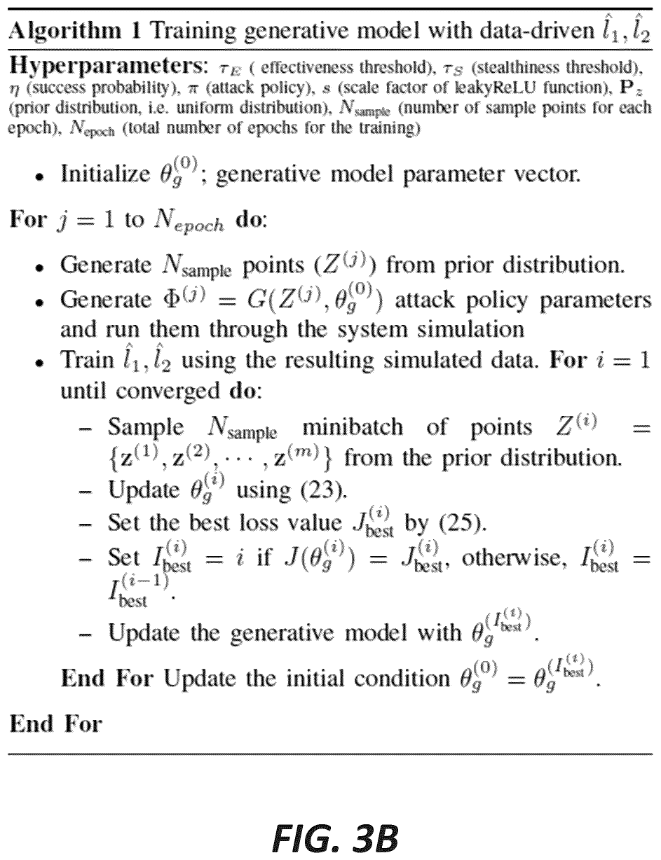

FIG. 3A illustrates an example algorithm implementing the method of FIG. 2A. Example 1, herein, further describes the example algorithm of FIG. 3A.

FIG. 2B illustrates another example method according to implementations of the present disclosure. The method of FIG. 2B can be used to configure the cybersecurity system 100, for example by configuring the trained machine learning model 110 and/or controller 112. At step 220 the method includes receiving a generative model parameter vector.

At step 222 the method includes generating sample points from a prior distribution of the generative model parameter vector.

At step 224 the method includes generating attack policy parameters. Non-limiting examples of attack policy parameters include a ramp attack policy, sine attack policy, and pulse attack policy. The present disclosure contemplates that combinations of attack policy parameters can also be used.

At step 226 the method includes simulating simulated attack policy parameters by a system simulation.

At step 228 the method includes training a generative model by the simulated attack policy parameters. Optionally the generative model is a deep neural network, as described in example 2 herein. The deep neural network can optionally select a best loss value by the function: J_{best}⁽ⁱ⁺¹⁾=min{J_{best}⁽ⁱ⁾,J(θ_{g}⁽ⁱ⁺¹⁾)}.

FIG. 3B illustrates an example algorithm implementing the method of FIG. 2B.

It should be appreciated that the logical operations described herein with respect to the various figures may be implemented (1) as a sequence of computer implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 1100 upon which the methods described herein may be implemented is illustrated. It should be understood that the example computing device 1100 is only one example of a suitable computing environment upon which the methods described herein may be implemented. Optionally, the computing device 1100 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1100 typically includes at least one processing unit 1106 and system memory 1104. Depending on the exact configuration and type of computing device, system memory 1104 may be volatile (such as random access memory (RAM)), non-volatile (such as read-only memory (ROM), flash memory, etc.), or some combination of the two. This most basic configuration is illustrated in FIG. 4 by dashed line 1102. The processing unit 1106 may be a standard programmable processor that performs arithmetic and logic operations necessary for operation of the computing device 1100. The computing device 1100 may also include a bus or other communication mechanism for communicating information among various components of the computing device 1100.

Computing device 1100 may have additional features/functionality. For example, computing device 1100 may include additional storage such as removable storage 1108 and non-removable storage 1110 including, but not limited to, magnetic or optical disks or tapes. Computing device 1100 may also contain network connection(s) 1116 that allow the device to communicate with other devices. Computing device 1100 may also have input device(s) 1114 such as a keyboard, mouse, touch screen, etc. Output device(s) 1112 such as a display, speakers, printer, etc. may also be included. The additional devices may be connected to the bus in order to facilitate communication of data among the components of the computing device 1100. All these devices are well known in the art and need not be discussed at length here.

The processing unit 1106 may be configured to execute program code encoded in tangible, computer-readable media. Tangible, computer-readable media refers to any media that is capable of providing data that causes the computing device 1100 (i.e., a machine) to operate in a particular fashion. Various computer-readable media may be utilized to provide instructions to the processing unit 1106 for execution. Example tangible, computer-readable media may include, but is not limited to, volatile media, non-volatile media, removable media and non-removable media implemented in any method or technology for storage of information such as computer readable instructions, data structures, program modules or other data. System memory 1104, removable storage 1108, and non-removable storage 1110 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1106 may execute program code stored in the system memory 1104. For example, the bus may carry data to the system memory 1104, from which the processing unit 1106 receives and executes instructions. The data received by the system memory 1104 may optionally be stored on the removable storage 1108 or the non-removable storage 1110 before or after execution by the processing unit 1106.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

An example implementation of the present disclosure includes an attack generation framework for evaluating the vulnerability of nonlinear networked pipeline systems.

As used in the present example, [symbol] ⁿ, [symbol] ₊ denotes the space of real vectors of length n and positive real numbers respectively. The probability triple is denoted by (Ω, [symbol] , P_{Z}) [9], where Ω is a sample space containing the set of all possible outcomes, [symbol] is an event space, and P_{z} is the associated probability functions of the events in [symbol] . The study used the symbol [symbol] to denote the expected value operator. An undirected graph [symbol] (V, ε) contains vertices, denoted by ε={v₁, v₂, . . . , vₙ}, and edges, denoted by ε∈V×V.(v₁, v₂) and (v₁, v₂)∈ε represents an edge in [symbol] . Consequently, the adjacency matrix, denoted by A( [symbol] ), is a square matrix of size |V|, defined as [10]

$${A}_{ij} = \{ \begin{matrix}1 & if ( {v}_{i} , {v}_{j} ) ∈ ε \\ 0 & otherwise\end{matrix}$$

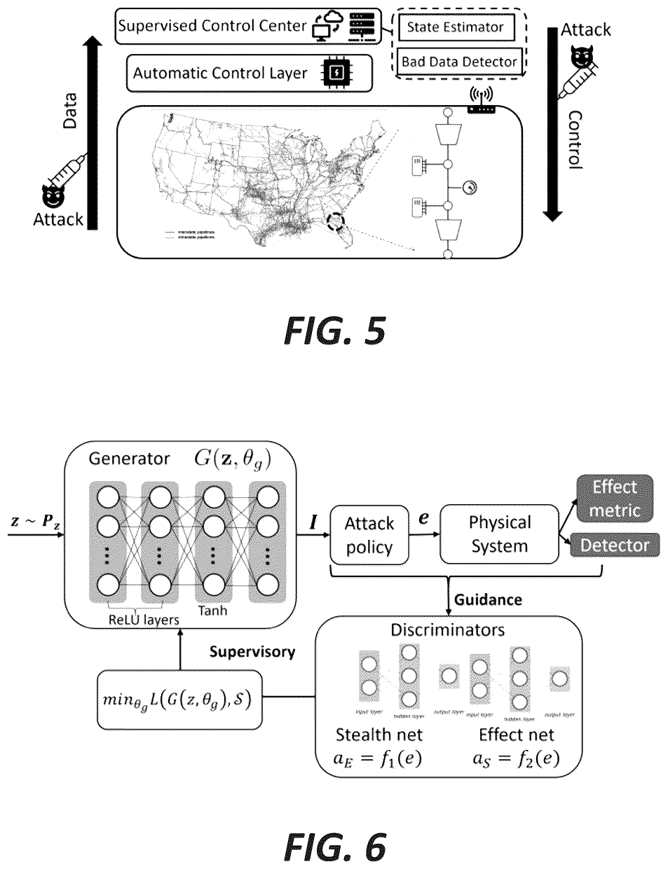

An example implementation was studied with a model of a networked pipeline system, including the physical plants, network dynamics, a supervisory control and data acquisition (SCADA) system, and an attack model. FIG. 5 illustrates the system, featuring two control layers. The supervised control layer collects measurement data from IoT sensors across the network, estimates system states, identifies measurement errors, and generates the reference for the local controllers. The automatic control layer includes lower-level controllers of the compressor stations.

A nonlinear creep flow model was used to describe the gas flow in a pipeline segment [11]:

$$\frac{\partial p}{\partial t} = - \frac{{c}^{2} ρ}{G} \cdot \frac{\partial {Q}_{n}}{\partial x} , \frac{\partial p}{\partial x} = - \frac{2 f {ρ}^{2} {c}^{2} {Q}_{n}^{2}}{{DG}^{2} p} \qquad ( 1 )$$

where p is the pressure in the pipeline, x is the position of flow, c is the speed of sound in gas [m/s], ρ is the average gas density over the cross-section area of the pipeline [kg/m³], Qₙ is the volumetric flow at standard conditions, f is the friction factor, D is the diameter of the pipeline and G=π(D/2)². While the partial differential equation (PDE) model provides an accurate description of the gas flow dynamics for infrequent online optimization, an ordinary differential equation (ODE) model is sufficient to describe the pressure dynamics at nodes [11]. The dynamical pressure model at node i is given as

$$\begin{matrix}{p}_{i} = \frac{{c}^{2}}{{V}_{i}} {\sum }_{j ∈ {𝒩𝒩}_{i}} \sqrt{\frac{\vert {p}_{j}^{2} - {p}_{i}^{2} \vert}{{K}_{ij}}} sgn ( {p}_{j} - {p}_{i} ) - {w}_{i} \\ where {K}_{ij} = \frac{64 {f}_{ij} {c}^{2} Δ {x}_{ij}}{{π}^{2} {D}_{ij}^{5}} , {V}_{i} = \frac{π}{8} {\sum }_{j ∈ {𝒩}_{i}} {D}_{ij}^{2} Δ {x}_{ij} ,\end{matrix} \qquad ( 2 )$$

and wᵢ is the mass flow at pipeline i, Δxᵢⱼ denotes the length of pipeline between node i and node j, [symbol] denote the set of neighborhood pipelines of the pipeline i. Let

$$ψ ( {p}_{i} , {p}_{j} ) {=}^{△} \sqrt{\frac{\vert {p}_{j}^{2} - {p}_{i}^{2} \vert}{{K}_{i j}}} sgn ( {p}_{j} - {p}_{i} )$$

$$and$$

$$Ψ ( p ) {=}^{△} [ \begin{matrix}0 & ψ ( {p}_{1} , {p}_{2} ) & … & ψ ( {p}_{1} , {p}_{n} ) \\ ψ ( {p}_{2} , {p}_{1} ) & 0 & … & ψ ( {p}_{2} , {p}_{n} ) \\ ⋮ & ⋮ & ⋱ & ⋮ \\ ψ ( {p}_{n} , {p}_{1} ) & ψ ( {p}_{n} , {p}_{2} ) & … & 0\end{matrix} ]$$

then the model of the entire pipeline network is given by:

$$\begin{matrix}\dot{p} = {c}^{2} {V}^{- 1} ( A ⊙ Ψ ( p ) ) 1 - w \\ = {c}^{2} {V}^{- 1} ( A ⊙ Ψ ( p ) ) 1 + {B}_{sup} {w}_{sup} - {B}_{d e m} {w}_{d e m} \\ {=}^{△} f ( p , w )\end{matrix}$$

where V⁻¹=diag([V₁⁻¹, V₂⁻¹, . . . , Vₙ⁻¹]), wₛᵤₚ is a vector of mass inflows at the supply points and w_{dem} is a vector of mass outflows at the demand points. Clearly w=−Bₛᵤₚwₛᵤₚ+B_{dem}w_{dem}, where B_{dem} and Bₛᵤₚ are appropriately dimensioned matrices such that Bₛᵤₚ^{T}B_{dem}=0 and P[−Bₛᵤₚ|B_{dem}]=I for some projection matrix P. In addition, a dynamical model of the compressor between two nodes i and j is given by [12]:

$${\dot{ω}}_{i j} = \frac{1}{{J}_{{0}_{i}}} ( {u}_{i j} + ρ {r}_{2}^{2} {q}_{i j} {ω}_{i j} )$$

$${\dot{w}}_{i j} = {q}_{i j}$$

where

$$ϕ ( ω , q ) = {( 1 + \frac{1}{{T}_{i n} {c}_{p} 1000} ( ρ {r}_{2}^{2} {ω}^{2} + {k}_{f} {q}^{2} - \frac{{r}_{1}^{2}}{2} {( ω - \frac{q}{{A}_{c} {r}_{1} {ρ}_{i n}} )}^{2} ) )}^{\frac{γ}{γ - 1}} ,$$

ωᵢⱼ is the compressor rotor angular velocity [rad/s], qᵢⱼ is the mass power flow [kg/s], ϕ(ω, q) is the compressor characterization, uᵢⱼ is the mechanical torque [N-m] applied to the rotor shaft or inertia J₀_{ᵢ} [kg-m²]. pᵢ and pⱼ are the input and output pressures of the compressor, respectively. For the system considered, the compressors are at the extremes of the network. Thus, at each compressor node, one of pᵢ and pⱼ will be the ambient pressure. pᵢ=P_{amb} for upstream compressors, while pⱼ=P_{amb} for downstream compressors.

A supervised control framework was employed to stabilize pipeline pressure and regulate mass flow, compromising a supervised control layer and an automatic control layer. The supervised control layer contains an estimator, a bad data detector (BDD), and a supervised controller. The pipeline system is equipped with hundreds of smart pressure and flow meters, the goal of the estimator at the supervised control layer is to fuse the meter readings and estimate the states of interest p. The measurement model is given as

$$y = g ( p , w ) \qquad ( 5 )$$

Then an unscented Kalman Filter (UKF) is utilized to perform sensor fusion and state estimation. Firstly, following standard unscented transformation, the study used 2n+1 sigma points to approximate the state p with assumed mean p̅ and covariance Pₚ as follows:

$${χ}_{0} = \overline{p} , {χ}_{i} = \overline{p} + {( \sqrt{( λ + n ) {P}_{p}} )}_{{i}^{′}} , i = 1 , … , n$$

$${χ}_{i + n} = \overline{p} + {( \sqrt{( λ + n ) {P}_{p}} )}_{i - n} , i = n + 1 , … , 2 n$$

The corresponding weights for the sigma points are given as W₀^{m}=λ/(n+λ), W₀^{c}=W₀^{m}+(1−α²+β), Wᵢ=½(L+λ), and λ=α²(n+κ)−n represents how far the sigma points are away from the state, κ≥0, α∈(0,1], and β=2 is the optimal choice for Gaussian distribution. Assuming pₖ₋₁˜ [symbol] (p̅ₖ₋₁, P_{p,k-1}), the prediction step is given by:

$${\hat{p}}_{k}^{-} = {\sum }_{i = 0}^{2 n} {W}_{i} g ( {x}_{k - 1} , {w}_{k} ) , {\hat{y}}_{k}^{-} = {\sum }_{i = 0}^{2 n} {W}_{i} {k , i}_{}$$

$${\hat{P}}_{p , k} = {\sum }_{i = 0}^{2 n} {W}_{i} ( g ( {X}_{k - 1} , {w}_{k} ) - {\hat{x}}_{k} ) {( g ( {X}_{k - 1} , {w}_{k} ) - {\hat{x}}_{k} )}^{T} + R$$

where [symbol] =f(g(Xₖ₋₁, wₖ)). The correction step is given by

$${\hat{p}}_{k} = {\hat{p}}_{k}^{-} + {K}_{k} ( {y}_{k ,} - {\hat{y}}_{k ,} ) , {P}_{p , k} = {\hat{P}}_{p , k} - {K}_{k} {\hat{P}}_{y , k} {K}_{k}^{T} \qquad ( 6 )$$

where the Kalman gain is Kₖ=\hat{P}_{py}\hat{P}_{y,k}⁻¹ with:

$${\hat{P}}_{y , k} = {\sum }_{i = 0}^{2 n} {W}_{i} ( {k , i}_{} - {\hat{y}}_{k ,} ) {( {k , i}_{} - {\hat{y}}_{k ,} )}^{T} + Q ,$$

$${\hat{P}}_{p y} = {\sum }_{i = 0}^{2 n} {W}_{i} ( {X}_{k , i}^{⋆} - {\hat{p}}_{k} ) {( {( k , i ) ,}_{} - {\hat{y}}_{k ,} )}^{T} ,$$

and Q and R are the measurement and process noise covariance matrices respectively. Bad data detector (BDD) is defined as a function D: [symbol] ⁿ× [symbol] ^{p}× [symbol] ^{m}→ [symbol] ₊ mapping from the state estimates to a detection residual (i.e. 1-norm or 2-norm residual-based detectors [13], [14]) or a detection likelihood (i.e. χ² detector [15], [8]).

$${r}_{i} = D ( {\hat{p}}_{i} , {y}_{i} , {w}_{i} ) \qquad ( 7 )$$

Linearizing the models around the equilibrium point (p_{eq}, w_{eq}) and discretizing with a fixed time step Tₛ yields:

$$Δ {p}_{k + 1} = A Δ {p}_{k} + B Δ {w}_{k} \qquad ( 8 )$$

where Δpₖ=pₖ−p_{eq}, Δwₖ=wₖ−w_{eq}, and

$${{{A = \frac{\partial f}{\partial p} \vert}_{( {p}_{eq} , {w}_{eq} )} {T}_{S} + {I}_{n} , B = \frac{\partial f}{\partial w} \vert}_{( {p}_{eq} , {w}_{e q} )} {T}_{S} , C = \frac{\partial g}{\partial p} \vert}_{{P}_{eq}}$$

Then, a model predictive controller of horizon length h is utilized to generate the reference mass flow w^{r}:

$${Minimize}_{Δ {p}_{[ k , k + h ]} , Δ {w}_{[ k , k + h ]}} : {\sum }_{t = 0}^{h} \frac{1}{2} Δ {p}_{t}^{⊤} {M}_{1} Δ {p}_{t} + {\sum }_{t = 0}^{h - 1} \frac{1}{2} Δ {w}_{t}^{⊤} {M}_{2} Δ {w}_{t}$$

$$Subject to : Δ {p}_{t + 1} = A Δ {p}_{t} + B Δ {w}_{t} , t = 0 , … , h - 1$$

Thus, the reference mass flow is given as wₖ^{r}=Δw*_{[k]}+w_{eq}. Next, at the automatic control layer, a PID controller is used to control the compressors to track the reference mass flow.

$${u}_{i j} = {K}_{P} e ( t ) + {K}_{I} {\int }_{0}^{t} e ( τ ) d τ + {K}_{D} \frac{de ( t )}{dt} \qquad ( 10 )$$

where e(t)=wᵢⱼ−wᵢⱼ^{r}, and the PID gains K_{P}, K_{I}, K_{D} are designed to achieve lim_{t→∞}∥e(t)∥=0.

In the example study, attacks can be injected through the sensing process and actuation process, and it can be modeled as [15], [14]

$$\dot{p} = f ( p , w + {e}^{u} )$$

To characterize the effect of attacks in the system (11), effectiveness and stealthiness are two common criteria [3]. The study used l₁: [symbol] ^{m}× [symbol] ^{p}→ [symbol] , l₂: [symbol] ^{m}× [symbol] ^{p}→ [symbol] to denote functions evaluating the effectiveness and stealthiness of the attacks respectively. Then a feasible set of attacks S is defined with given thresholds of effectiveness and stealthiness τ_{E}, τ_{S}:

$$= \{ {e}^{u} ∈ {Σ}_{{k}_{u}} , {e}^{y} ∈ {\sum }_{{k}_{y}} \vert {l}_{1} ( {e}^{u} , {e}^{y} ) \geq {τ}_{E} , {l}_{2} ( {e}^{u} , {e}^{y} ) \leq {τ}_{S} \} \qquad ( 12 )$$

Most research uses the estimation error to represent the effectiveness of sensor attacks such that l₁=∥\hat{x}ᵢ−xᵢ∥[13], [14]. The stealthiness function often employs the BDD function l₂=D, where D is defined in (7).

Consequently, the attack generation problem is finding a generative model of the form

$$G ( z , θ ) : ( Ω , , {P}_{z} ) \times {ℝ}^{{n}_{g}} \to {ℝ}^{n} \qquad ( 13 )$$

with a constant tunable parameter vector θ∈ [symbol] ⁿ^{_{g}}, and a prior probability sample space (Ω, [symbol] , P_{Z}) with random variables z˜P_{z}, such that

$$Pr \{ G ( z , θ ) ∈ \} \geq α \qquad ( 14 )$$

for some α∈(0,1). Essentially, G(z, θ) is a generative model for the set [symbol] if G(z, θ)∈ [symbol] with a high probability given by the lower bound α. However, obtaining the close-form expressions of l₁ and l₂ can be challenging due to their complex composition of the models from (2) to (10). Moreover, searching for feasible attacks in [symbol] is at least an NP-hard problem due to the nonlinearity and nonconvexity of the problem. To address these challenges, implementations of the present disclosure can include a data-driven approach that can include two discriminators learning l₁ and l₂ from runtime data, and a generator learning how to solve this NP-hard attack generation problem.

The study introduced a solution to search for feasible attacks in the set [symbol] defined in (12) using only the runtime data of NPS. The data-driven attack generation framework is illustrated in FIG. 6. The runtime data is obtained from the physical experiment and is used to guide the training of the discriminators. The trained discriminators then supervise the learning process of the generator.

The generator G(z, θ) can be a deep neural network learning the distribution of feasible attacks from sampling noise. It can optionally be trained with the loss function

$$L ( G ( z ; θ ) ) = ReLU ( {𝔼}_{z \sim {P}_{z}} [ D ( G ( z ; θ ) ) ] - ( 1 - α ) ) \qquad ( 15 )$$

where D function is given by:

$$D ( e ) = exp [ {Leaky ReLU}_{s} ( {τ}_{E} - {l}_{1} ( e ) )$$

where e=[e^{uT} e^{yT}]^{T}. Then the following minimization program is employed to train the generator and solved by gradient descent.

$${θ}^{★} = {arg min}_{θ} {𝔼}_{z \sim {P}_{z}} L ( G ( z ; θ ) ) \qquad ( 17 )$$

Successful training of the generator can require knowledge of l₁ and l₂ functions. However, it is hard to obtain their closed-form expression. Data-driven approximation offers a practical solution, as it only requires runtime data instead of a high-fidelity model and provides easy calculation of gradients. The study used two deep regression neural networks to approximate l₁ and l₂:

$${a}_{E} = {f}_{1} ( e ; {θ}_{E} ) , {a}_{S} = {f}_{2} ( e ; {θ}_{S} ) \qquad ( 18 )$$

They are both trained with the mean-square-error (MSE) loss function given N runtime effectiveness metric data l₁(e) with the corresponding injection of attacks e:

$${Minimize}_{{θ}_{E}} : \frac{1}{N} {\sum }_{j = 1}^{N} {‖ {{l}_{1} ( e )}^{( j )} - {{f}_{1} ( e ; {θ}_{E} )}^{( j )} ‖}_{2}^{2} \qquad ( 19 )$$

and given N runtime stealthiness metric data l₂(e) with the corresponding injection of attacks e:

$${Minimize}_{{θ}_{S}} : \frac{1}{N} {\sum }_{j = 1}^{N} {‖ {{l}_{2} ( e )}^{( j )} - {{f}_{2} ( e ; {θ}_{S} )}^{( j )} ‖}_{2}^{2} \qquad ( 20 )$$

The generator maps random samples z˜P_{z} to the parameter vector I∈ [symbol] ^{p} of a pre-defined attack policy π(I). Given I∈ [symbol] ^{p}, the attack policy π(I) is a deterministic time sequence of the injected attacks given by

$$π ( I ) {=}^{Δ} \{ {t}_{0} ( I ) , T ( I ) , g ( I ) \}$$

It can include the start time of the attack injection t₀(I), the duration of the attack injection T(I), and the attack profile g(I): [t₀(I)t₀(I)+T(I)]→ [symbol] ⁿ. The specific attack policy is assumed to be predetermined for the purpose of the example implementation studied.

Biased learning can be a concern in deep generative models [16], particularly when trained with multiple interrelated data-driven models. The discriminators might learn biased l₁ and l₂ functions based on a limited space of attacks covered by the generative model. This in turn affects the training of the generator network. To improve and address biased learning issues, implementations of the present disclosure can incorporate random and generated attack datasets into the discriminator training process. An example training procedure can include: Receiving Hyperparameters: τ_{E}, τ_{S}, α, π, s;
Generating a random parameter vector I, implement the attack policy π(I) in system experiment and obtain a random attack dataset {[l₁, l₂, l₃], [a_{E}, a_{S}]}_{rand};
For i in N_{epoch}:
Passing a batch of m samples {z⁽¹⁾, z⁽²⁾, . . . , z^{(m)}}˜P_{z} through the generator to obtain [I₁, I₂, I₃]=G(z, θᵢ₋₁);
Performing a corresponding attack policy π(G(z, θᵢ₋₁)) in system experiment and obtain a generated attack dataset {[I₁, I₂, I₃], [a_{E}, a_{S}]}_{gen}
Training discriminators using both random attack dataset and the current generated attack dataset→(19), 20p;
Training the generator using the trained discriminators in the loss function (15), where l₁(e)=f₁(e, θ_{E}_{ᵢ}) and l₂(e)=f₂(e, θ_{S}_{ᵢ}).

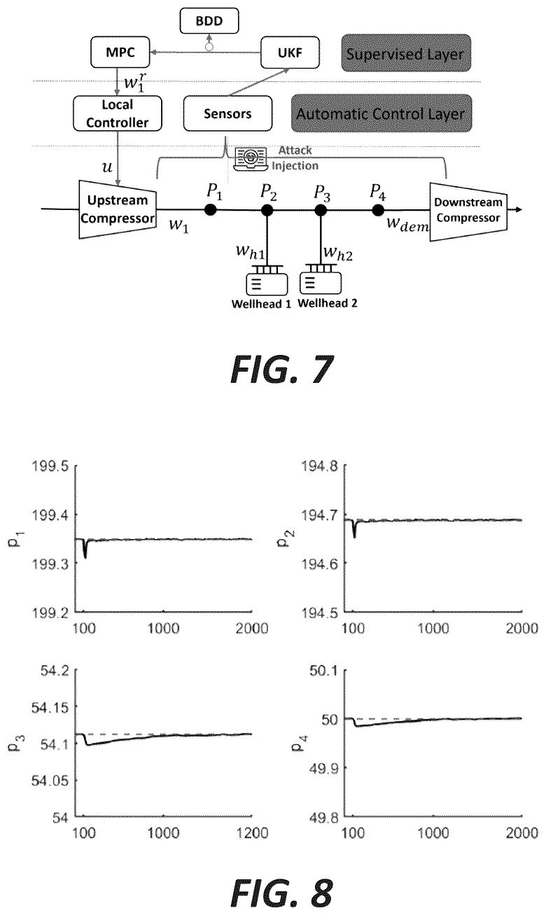

A simulation was performed to evaluate the proposed attack generative model on a 4-node pipeline system, as depicted in FIG. 7. The objective is to regulate the node pressures at their corresponding equilibrium point p_{eq}, while meeting the demanding mass flow w_{dem} at node 4 and subject to the flow supply wₕ₁ and wₕ₂ at the two wellheads. To this end, the supervised MPC controller (9) generates the reference mass flow w₁ at node 1 using the UKF estimation (6) of the node pressure and the mass flow in the other pipelines. Subsequently, the local PID controller 10) controls the compressor to regulate the pipeline flow supplied to the node 1.

The topology of the network can be represented by the adjacent matrix:

$$A = [ \begin{matrix}0 & 1 & 0 & 0 \\ 1 & 0 & 1 & 0 \\ 0 & 1 & 0 & 1 \\ 0 & 0 & 1 & 0\end{matrix} ] \qquad ( 21 )$$

The pipeline model parameters were chosen as c=330 m/s, D₁₂=0.8 m, D₂₃=0.5 m, D₃₄=1.5 m, Δx₁₂=Δx₂₃=Δx₃₄=10 m, f₁₂=f₂₃=f₃₄=0.0025. The compressor model parameters are chosen as J₀=47.7465, ρr₂²=0.0951, Tᵢₙ cₚ=13322.3, k_{f}=0.05, r₁=20, A_{c}r₁ρᵢₙ=0.5834, γ=1.2, and A_{c}/r_{c}=0.0146

In the simulation, the study targeted the equilibrium point p_{eq}=[199 194 54 50]^{T}, corresponding to the equilibrium point of the mass flow w_{eq}=[−20 −5 −5 13]^{T}. FIG. 8 illustrates an example of the nominal control performance, where a disturbance d=0.1 is injected into pressure measurements during [100 s, 120 s]. The supervisory control framework successfully regulates the node pressures back to their desired equilibrium point. The UKF is used to estimate 4 node pressure p₁˜p₄ and 3 mass flow wₕ₁, wₕ₂, w_{dem} from their noisy measurements. The BDD can then be defined as

$$r = {‖ y - g ( \hat{x} ) ‖}_{2} \qquad ( 22 )$$

where \hat{x}=[\hat{p}^{T} wₕ₁ wₕ₂ w_{dem}]^{T}. This BDD residual r is used for the stealthiness metric. And the effectiveness metric is given by the control error

$$e = {‖ p - {p}_{eq} ‖}_{2} \qquad ( 23 )$$

The objective of the attack generation task is to fool UKF into giving biased estimates \hat{x}^{a} leading to small r but big e. The feasible attack set is given particularly as:

$$= \{ {e}^{y} \vert e \geq 10 , r \leq 0 \text{.2} \} \qquad ( 24 )$$

where e^{y} is injected through the measurements as shown in 11). The study used an example attack policy called ramp attack policy π(I)={t₀(I),T(I),g(I)} through each channel, given by:

$$\begin{matrix}{t}_{0} = {t}_{l} + ( {t}_{r} - {t}_{l} ) {I}_{2} \\ T = {T}_{l} + ( {T}_{r} - {T}_{l} ) {I}_{3}\end{matrix}$$

Here ē is the maximum magnitude of the attack signal. The attack injection start time t₀∈[tₗ tᵣ] and the duration time T∈[Tₗ Tᵣ]. The study use e=0.5, tₗ=20 s, tᵣ=40 s, Tₗ=0 s, Tᵣ=100 s and the simulation time for generator training is set as 200 s. These exact values of t₀, T, e at runtime are specified by the parameters I∈ [symbol] ³ generated by the generator.

Next, the study implemented the example algorithm with τ_{E}=10, τ_{S}=0.2, α=0.8, s=0.01 and π given by 25. The generator employed was a deep neural network composed of 4 layers, ReLU, ReLU, Tanh, Sigmoid, with 500, 1000, 500, 3n neurons respectively, where n is the number of nodes under attack. The input size was set as 10. The stealth net includes of 3 ReLU hidden layers and Sigmoid output layer, and the effect net includes of 3 ReLU hidden layers and Linear output layer. The numbers of neurons at layers are 500, 1000, 500, 1 for both effect net and stealth net. They are trained by (20) and 19) respectively. Adams optimizer, in Matlab deep learning toolbox, is used with the learning rate 0.0002, gradient decay factor 0.5, and square gradient decay factor 0.999. The study trained the framework in 5 epochs. In each epoch, the generator trained 10 batches of 5000 batch size, while the discriminators are trained 200 batches of 1000 batch size.

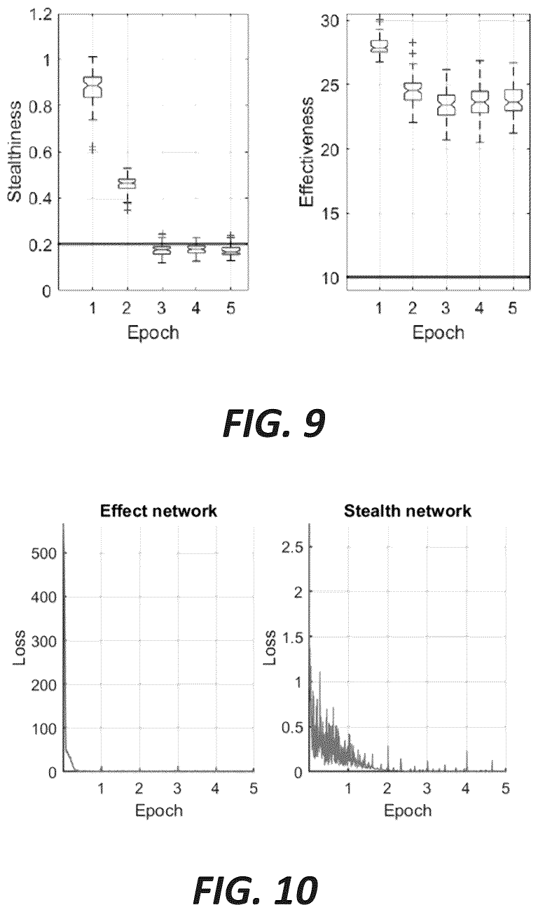

After each epoch of training, the performance of the attack generator is tested in a real system simulation, as shown in FIG. 9. The generated attacks become more stealthy (stealthiness metric value decrease) as the training epoch increases, while their effectiveness is also sacrificed in the first 2 epochs. However, once the stealthiness falls below the threshold 0.2, the generator increases effectiveness from epoch 3 to epoch 5. The F₁ score of generating feasible attacks in the set S defined in 24 is increasing from 0 to 0.86. The training loss curves of discriminators are shown in FIG. 10. It is seen that, at the first 2 epochs, the training of discriminators does not converge yet, so the performance of the attack generator also has bigger deviations as shown in FIG. 9. As the number of epochs increases, the convergence of the generator and two discriminators can arrive simultaneously.

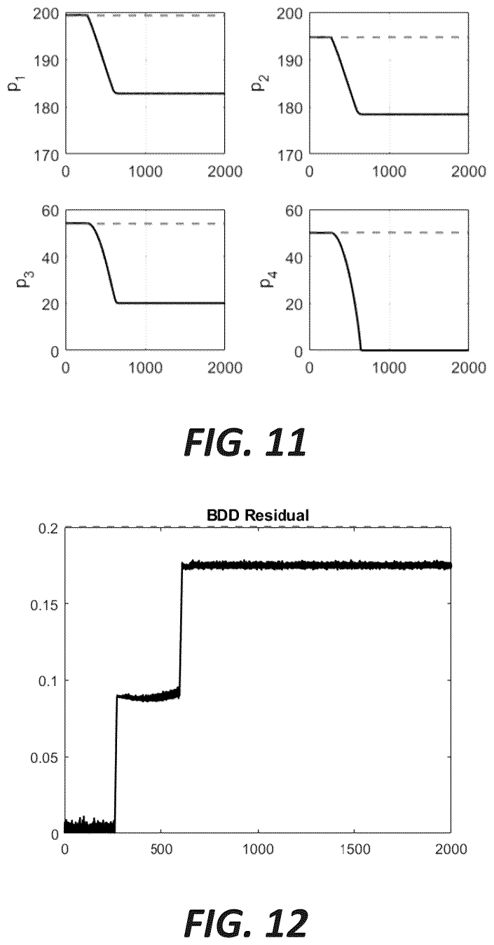

Finally, the study demonstrated the effectiveness of the proposed attack generation method through a time-series performance of generated feasible attacks in FIG. 11. The attacks caused the state estimator to output incorrect estimations of the pipeline flow and current node pressures. Then the controllers were driven to adjust the node pressures towards other malicious equilibrium points. Despite this, the stealthiness value, shown in FIG. 12, remained below the threshold, indicating that the attacks were able to remain undetected.

The example described herein implements a data-driven attack generative model that can be used for NPS vulnerability analysis. The framework includes three interactive data-driven models: two discriminative models to evaluate attack signals and a generative model to generate feasible attacks. The loss function disclosed ensures successful attack generation.

It should be understood that the example in the study is non-limiting, and that other loss functions and/or applications of implementations of the present disclosure are contemplated. For example, the present disclosure contemplates interactive training between the proposed attack generator and a supervised learning-based attack detector, which can lead to a complete automatic exploration of the vulnerability space and the development of a perfect attack detector for the system.

### Example 2

A second study was performed on a second example implementation of the present disclosure. The second study included improvements to modeling and design of cyber-physical systems to reduce vulnerability to cyber attacks. As used in the present study, the summation symbol used here is a generalized summation for the appropriate random variable. If the random variable is continuous, then the summation symbol will be considered an integral sign. If the random variable is discrete, then the summation symbol will be the traditional summation of countable quantities. Let x₁, x₂∈ [symbol] . Then, ReLU(x₁)≤ReLU(x₂) implies that x₁≤x₂. Otherwise, x₁≤0 and x₂≤0—in which case ReLU(x₁)=ReLU(x₂)=0.

Modern cyber-physical infrastructure systems (CPIS) are built based on the seamless integration of physical devices and computer systems, facilitating data exchange and control of physical processes [1A]. As the complexity and scale of CPIS increase, network structures are utilized to leverage the resources and capabilities of subsystems, resulting in improved functionality and performance [2A]. In such NCPS, the physical agents, sensors, and actuators are tightly interconnected or coupled through communication networks to gather and analyze data and perform physical actions in response to high-level commands or unwanted external influence. NCPSs are used in various applications, such as smart power grids [3A], industrial pipeline systems [4A], and transportation systems [5A]. The networked and distributed integration of computer systems and physical devices provides numerous benefits, including improved efficiency, reduced costs, and increased safety [6A]. However, networked information transmission presents significant security and privacy challenges as they are vulnerable to cyber-attacks and data breaches [7A]. Therefore, the development of secure and reliable NCPS is essential to ensure their safe and effective operation [8A].

Assessing the vulnerability of NCPS is a challenging task that requires a deep understanding of the complex interplay between the physical and cyber components of the system and the potential attack scenarios. Various techniques to address the vulnerability analysis problem in cyber-physical systems (CPS) exist, but are limited. Such techniques can include mathematical and analytical methods, as well as data-driven and simulation-based approaches. Early researchers incorporated the full system model into the maximization program to generate a feasible attack [9A]-[11A]. In [9A], a false data injection attack (FDIA) was studied against the least-square estimator with a residual-based bad data detector (BDD). The feasibility of FDIA against the Kalman filter with χ\hat{ }2 detector was studied in [10A]. One study defined vulnerability under sensor attacks as the boundedness of the estimation error and derived sufficient and necessary conditions through analysis of the system's reachable zero dynamics [12A]. A sufficient and necessary condition for insecure estimation under FDIA was also derived for a networked control system in [11A]. To develop more pragmatic attack generation strategies, several constraints are incorporated to capture the attacker's limitations such as limited access to sensors [9A], shallow knowledge of system dynamics [13A], and incomplete knowledge of implemented state estimators [14A]. However, these model-based approaches primarily target linear CPS.

Given the nonlinear nature of NCPSs and the challenges associated with obtaining high-fidelity models, the corresponding vulnerability analysis problem is significantly more complex [15A]. One approach is to analyze vulnerability based on domain knowledge and extensive simulations. For instance, [16A] combined a stochastic adversarial model with a simulation model of interdependent gas-electricity delivery infrastructures to explore operational disruptions caused by cyber-attacks. Another study in [17A] employed hierarchical Limited Stochastic Petri nets and power system network topology to simulate intrusion attack scenarios. Furthermore, a dynamic network security vulnerability assessment method was developed for SCADA systems, taking into account software vulnerabilities and deployed network security defense measures [18A]. However, simulation-based approaches may only be possible for a specific system with specific attack.

Alternatively, data-driven approaches can provide more general solutions. In [19A], [20A], generative adversarial networks (GANs) were trained to learn from existing feasible attack datasets, but their performance relies heavily on the availability of non-generative attack datasets and the representative quality of the training data. Another approach in [15A] utilized data-driven models to approximate the system model, thereby reducing the complexity of solving the optimization-based attack generation problem. However, the optimization-based generator produces a specific attack rather than exploring the vulnerability space.

While existing approaches have been shown to be effective in various applications, they have limitations in capturing the nonlinear nature of NCPSs, relying on exact system model information or prior attack datasets, and being unable to explore vulnerability space. The study disclosed an example implementation including an attack generative framework that overcomes these limitations by integrating knowledge of the underlying physics of NCPS and a data-driven attack generative methodology. A tailored loss function for training the proposed model is given, with backing theoretical guarantees for convergence and probabilistic coverage of the vulnerability space. The example implementation can be applicable to both linear and nonlinear systems without relying on exact model knowledge assumption or prior attack datasets. The example implementation can include a unified attack generation framework for any NCPS. The proposed attack generation system was validated on an IEEE 14-bus system and various gas pipeline systems.

As used in the present example, [symbol] ⁿ, [symbol] ₊ and [symbol] ² denote the Euclidean space of dimension n, set of all positive real numbers, and the Hilbert space of all square summable signals of dimension n respectively. Normal-face lower-case letters (e.g. x∈ [symbol] ) are used to represent real scalars, bold-face lower-case letters (e.g. x∈ [symbol] ⁿ) represent vectors, while normal-face upper-case letters (e.g. X∈ [symbol] ^{m×n}) represent matrices. The study used xᵢ to denote the i th element of the vector x∈ [symbol] ⁿ and x(i) the vector signal x∈ [symbol] ⁿ at time i. dist(θ, Θ) is used to denote the Euclidean distance of a vector θ∈ [symbol] ⁿ to a set Θ*_{g}⊂ [symbol] ⁿ.

The probability triple is denoted by (Ω, [symbol] , P_{z}), where Ω is a sample space containing the set of all possible outcomes, [symbol] is an event space, and P_{z} is the associated probability functions of the event z in [symbol] . The study uses the symbol [symbol] to denote the expected value operator. The ReLU function is given by

ReLU(x)=max(0,x)
and LeakyReLU function is given by

$$LeakyReLU ( x ; s ) = max ( 0 , x ) + s min ( 0 , x )$$

for a given parameter s∈(0,1).

[symbol] (V, ε) denotes an undirected graph with vertices, denoted by ε={v₁, v₂, . . . , vₙ}, and edges, denoted by ε∈V×V.(v₁, v₂) and (v₁, v₂)∈ε represents an edge in [symbol] . Consequently, the adjacency matrix, denoted by A( [symbol] ), is a square matrix of size |V|, defined as [21A]

$${A}_{ij} = \{ \begin{matrix}1 & if ( {v}_{i} , {v}_{j} ) ∈ ℰ \\ 0 & otherwise\end{matrix}$$

The support of a vector x∈ [symbol] ⁿ is defined as supp(x) [symbol] {i⊆{1, . . . , n}|xᵢ≠0}. Σₖ [symbol] {x∈ [symbol] ⁿ∥supp(x)|≤k} denotes the set of k-sparse vectors. The study uses ⊙ to denote element-wise multiplication, i.e.

$$[ \begin{matrix}{a}_{11} & {a}_{12} \\ {a}_{21} & {a}_{22}\end{matrix} ] ⊙ [ \begin{matrix}{b}_{11} & {b}_{12} \\ {b}_{21} & {b}_{22}\end{matrix} ] = [ \begin{matrix}{a}_{11} {b}_{11} & {a}_{12} {b}_{12} \\ {a}_{21} {b}_{21} & {a}_{22} {b}_{22}\end{matrix} ]$$

The study uses ⊗ to denote Kronecker product, i.e. for B∈ [symbol] ^{m×n},

$$[ \begin{matrix}{a}_{11} & {a}_{12} \\ {a}_{21} & {a}_{22}\end{matrix} ] ⊗ B = [ \begin{matrix}{a}_{11} B & {a}_{12} B \\ {a}_{21} B & {a}_{22} B\end{matrix} ] ∈ {ℝ}^{2 m \times 2 n}$$

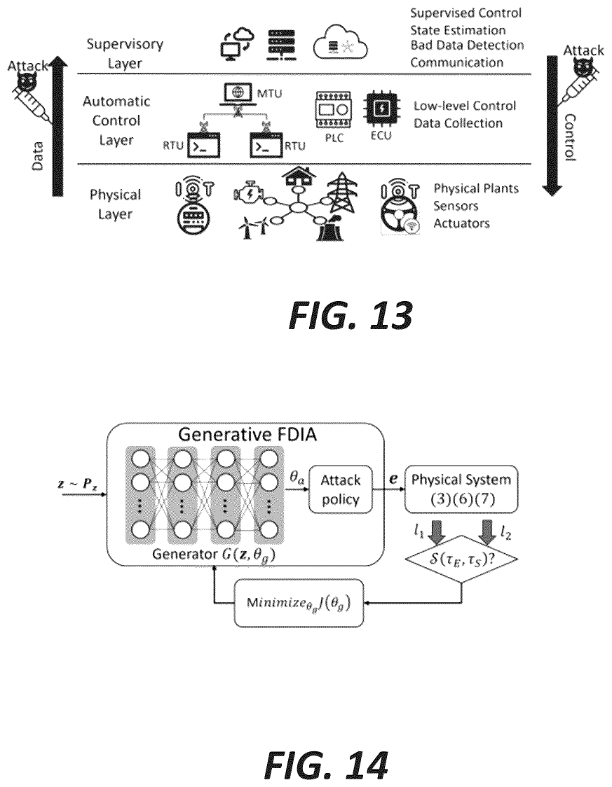

The study considers a networked CPS under attack. The networked CPS contains n nodes/agents with communication and computation capability. FIG. 13 illustrates the typical control structure of the networked CPS. The physical plants in the network are equipped with IoT sensors and/or actuators, which are controlled by automatic control units. Communication networks facilitate the sharing of sensing data, while a supervisory control center performs state estimation, bad data detection (BDD), and generates system targets. These targets are then communicated back to the networked plants. However, the transmission of data through the network is susceptible to malicious hackers. Injecting false data can have severe consequences in the physical world.

The example implementation included a system dynamical model. The physical process is modeled by the network dynamics given by:

$${\dot{x}}_{i} = {\sum }_{j ∈ {𝒩}_{i}} ψ ( {x}_{i} , {x}_{j} ) + {B}_{i} {z}_{i} \qquad ( 1 )$$

for each node i∈{1, 2, . . . , n}, where xᵢ∈ [symbol] ^{m}^{₁} is i th node's state vector, zᵢ∈ [symbol] ^{m}^{₂} is i-th node's actuation state, and [symbol] denotes the neighborhood of the i-th node/agent, which is the set of nodes physically linked with the i-th node. The physical layer dynamics and the interaction function ψ: [symbol] ^{m}^{₁}× [symbol] ^{m}^{₁}→ [symbol] ^{m}^{₁} are assumed to satisfy the following properties [22A]:

$$1. ψ ( {x}_{i} , {x}_{j} ) = 0 for i = j ,$$

$$2. ψ ( {x}_{i} , {x}_{j} ) = - ψ ( {x}_{j} , {x}_{i} ) for i \neq j ,$$

$$3. The underlying graph is undirected .$$

Let x=[x₁^{T} x₂^{T} . . . xₙ^{T}]^{T}∈ [symbol] ^{m}^{₁}ⁿ be an augmented network state vector composing of all nodal state vectors, the study defines the nodal interaction matrix

$$Ψ ( x ) {=}^{△} [ \begin{matrix}0 & ψ ( {x}_{1} , {x}_{2} ) & … & ψ ( {x}_{1} , {x}_{n} ) \\ ψ ( {x}_{2} , {x}_{1} ) & 0 & … & ψ ( {x}_{2} , {x}_{n} ) \\ ⋮ & ⋮ & ⋱ & ⋮ \\ ψ ( {x}_{n} , {x}_{1} ) & ψ ( {x}_{n} , {x}_{2} ) & … & 0\end{matrix} ] \qquad ( 2 )$$

Since the underlying graph is undirected, it is shown that the nodal interaction matrix Ψ satisfies the skewsymmetric properties; Ψ(x)^{T}=−Ψ(x) and η^{T}Ψ(x)η=0 for all X∈ [symbol] ^{m}^{₁}ⁿ and η∈ [symbol] ⁿ. Consequently, the entire network dynamics are given as

$$\dot{x} = ( A ⊙ Ψ ( x ) ) 1 + Bz \qquad ( 3 )$$

where A∈ [symbol] ^{n×n} is the adjacency matrix of the underlying undirected graph, B=blkdiag([B₁, B₂, . . . , Bₙ]) is the block diagonal matrix of all Bᵢ. The network dynamics in (3) is assumed to be controllable, namely; the state-dependent controllability matrix dimension subspace [23A], where L(x) is a state-dependent Laplacian matrix given by

$${L}_{ij} ( x ) = \{ \begin{matrix}- {\sum }_{j ∈ {𝒩}_{i}} \frac{\partial ψ ( {x}_{i} , {x}_{j} )}{\partial {x}_{i}} & if i = j \\ - \frac{\partial ψ ( {x}_{i} , {x}_{j} )}{\partial {x}_{j}} & if i \neq j\end{matrix} \qquad ( 4 )$$

Let [symbol] ₐ denote the index set of actuation nodes, then the actuation state vector zᵢ=0 if i∉ [symbol] ₐ, otherwise it follows an actuation dynamics described by the control-affine dynamical model, subject to actuation attacks:

$${\dot{z}}_{i} = {f}_{i} ( {z}_{i} ) + {g}_{i} ( {z}_{i} ) ( {u}_{i} + {e}_{{u}_{i}} ) \qquad ( 5 )$$

where uᵢ, eᵤ_{ᵢ}∈ [symbol] ^{p} are the i-th node's controlled actuation signal and injected attacks on actuators respectively. f, g are Lipchitz continuous on compact sets.

Next, a measurement model of equipped IoT sensors under attack is given by

$$y = h ( x ) + {e}_{y} + v \qquad ( 6 )$$

where y, e_{y}, v∈ [symbol] ^{m} are the measurement, sensor attacks, and sensor noise respectively. Let [symbol] =supp(eᵤ)⊂{1, 2, . . . , pn}, [symbol] =supp(e_{y})⊂{1, 2, . . . , m} denote the attack supports at actuation and sensing processes respectively. The study assumes that the attack signals are sparse. This is typically done in literature [24A] to capture limited resources available to the attacker. Thus, eᵤ∈Σₖ_{ᵤ} and e_{y}∈Σₖ_{_{y}}, where kᵤ<p, k_{y}<m.

The example implementation further included a nominal control design. Here, the study provides a control design for the nominal system without attacks (i.e. eᵤ=0, e_{y}=0). The materials in this subsection can be inferred from standard literature on nonlinear control design and are presented for the sake of completeness. The control design comprises 2 layers; (1) the low-level actuator control (Level 1), and (2) the supervisory reference generator (Level 2).

The low-level controllers are closed-loop schemes uᵢ: [symbol] ^{m}^{₂}→ [symbol] ^{p} designed to ensure that the actuator state zᵢ tracks a given reference zᵢ^{r}∈ [symbol] ^{p} such that

$$‖ \tilde{z} ( t ) ‖ \leq ‖ \tilde{z} ( 0 ) ‖ {e}^{- λ t} \qquad ( 7 )$$

where \tilde{z}ᵢ=zᵢ−zᵢ^{r} is the associated tracking error, λ>0 is the convergence rate. As a result, it is assumed that there exists a continuous differentiable, positive definite function V: [symbol] ^{m}^{₂}→ [symbol] which satisfies [25A]

$$\underline{α} ( ‖ \tilde{z} ‖ ) \leq V \leq \overline{α} ( ‖ \tilde{z} ‖ ) , \frac{\partial V}{\partial \tilde{z}} \dot{\tilde{z}} \leq - α ( ‖ \tilde{z} ‖ )$$

Thus, there exists a stabilizing controller of the form u=K(V(\tilde{z}))—for example using the Sontag formula [26A]

$$K ( V ( \tilde{z} ) ) = \{ \begin{matrix}- \frac{{L}_{f} V ( \tilde{z} ) + \sqrt{{[ {L}_{f} V ( \tilde{z} ) ]}^{2} + {[ {L}_{g} V ( \tilde{z} ) ]}^{4}}}{{L}_{g} V ( \tilde{z} )} & if {L}_{g} V ( \tilde{z} ) \neq 0 \\ 0 & if {L}_{g} V ( \tilde{z} ) = 0\end{matrix} \\ where {L}_{f} V ( \tilde{z} ) {=}^{△} 〈 \frac{\partial V}{\partial \tilde{z}} , f ( \tilde{z} ) 〉 , {L}_{g} V ( \tilde{z} ) {=}^{△} 〈 \frac{\partial V}{\partial \tilde{z}} , g ( \tilde{z} ) 〉 \qquad ( 8 )$$

are the Lie derivatives of V along f and g respectively.

The supervisory control generates the state reference z^{r} for the low-level controllers in order to regulate the network states x at the equilibrium point. Consistent with the time-scale separation inherent in a typical NCPS, the study assumes that the lowlevel control layer is much faster than the supervisory layer. Thus, for the purpose of designing a supervisory target generator, the study linearized the system dynamics about the operating point [27A]. The operating point is a known special equilibrium point for which the nominal operation of the CPS is designed. Examples of operating points include the nominal frequency and bus voltage of an AC transmission system (frequency of 60 Hz and voltage ranging from 230 KV to 500 KV for a typical transmission system in the United States). Although the nonlinear dynamics in (3) would have multiple equilibrium points, the study uses the known operating point as the equilibrium point of interest. Let x_{eq} be the equilibrium point of interest corresponding to the equilibrium points of inputs u_{eq}. Next, a linear model is used to approximate the network dynamical model in (3) around x_{eq}:

$$\dot{\tilde{x}} = - L ( {x}_{eq} ) \tilde{x} + Bz \qquad ( 9 )$$

where \tilde{x}=x−x_{eq} is the regulation error and L(x) is defined in (4).

Next, given a sample time step Tₛ, a discrete form of the linear model in (9) is given as:

$$\tilde{x} ( k + 1 ) = {\underbrace{( - L ( {x}_{eq} ) {T}_{s} + I )}}_{{A}_{d}} \tilde{x} ( k ) + {\underbrace{{BT}_{s}}}_{{B}_{d}} z ( k ) . \qquad ( 10 )$$

Consequently, a model predictive control (MPC) scheme is utilized to regulate the network states at the equilibrium point x_{eq}:

$${Minimize}_{{z}_{[ t , t + h - 1 ] ,}^{r}} : {\sum }_{k = 0}^{h} \frac{1}{2} {\tilde{x} ( k )}^{T} {M}_{1} \tilde{x} ( k ) + {\sum }_{k = 0}^{h - 1} \frac{1}{2} {{z}^{r} ( k )}^{T} {M}_{2} {z}^{r} ( k )$$

$${\tilde{x}}_{[ t , t + h ]}$$

$$Subject to : \tilde{x} ( k + 1 ) = {A}_{d} \tilde{x} ( k ) + {B}_{d} {z}^{r} ( k ) ,$$

$$k = 0 , … , h - 1 ,$$

The goal of the MPC program is to minimize the deviation from the operating point and the corresponding control energy using weight matrices M₁, M₂ respectively. The discrete error dynamics is imposed as an equality constraint. The initial constraint \tilde{x}(0)=\tilde{x}ₜ and terminal constraint \tilde{x}(k)=0 are imposed as another equality constraints. Since the network state x is not measurable, the regulation error is given by \tilde{x}(t)=\hat{x}(t)−x_{eq}, where the estimate of the network states \hat{x}ₜ is obtained using the following state estimator, given sensor measurements y.

The state estimator is a minimizer of the difference between model measurements and sensing readings in T horizon, according to the program

$${Minimize}_{{\hat{x}}_{[ t - T + 1 , t ]}} : {\sum }_{k = t - T + 1}^{t} {‖ y ( k ) - h ( \hat{x} ( k ) ) ‖}_{2}^{2}$$

$$Subject to : \tilde{x} ( k + 1 ) = {A}_{d} \tilde{x} ( k ) + {B}_{d} z ( k ) = 0$$

As the estimator estimates the network states from the measurements, a BDD monitors the state estimation process to detect any false inputs. It is defined as a function D_{∈}: [symbol] ^{m}^{₁}ⁿ× [symbol] ^{m}→ [symbol] ₊ mapping from the state estimates to a detection residual (i.e. 1-norm or 2-norm residual-based detectors [9A], [28A]) or detection likelihood (i.e. χ² detector [10A], [15A]).

$${r}_{t} = {D}_{ϵ} ( {\hat{x}}_{t} , {y}_{t} , {u}_{t} ) \qquad ( 13 )$$

The example implementation further included analyses of a vulnerability analysis problem.

Since obtaining a high-fidelity model for complex networked systems is challenging even for experienced practicing engineers and operators, the system models described in the present example are assumed to be unknown. However, for the purpose of vulnerability analysis, the study assumed that all measurement and actuation channels can be accessed. In other words, the study assumes all actuators and sensors are potential targets for attacks in order to cover all possible vulnerable scenarios. Additionally, the study assumes that the effectiveness and stealthiness of the injected attacks could be measured. Stealthiness refers to the potential to bypass BDD, while effectiveness represents the closeness to the intended degradation of system performance [11A]. Various metrics have can be used to measure effectiveness and stealthiness. For example, estimation error was used as the effectiveness metric while the estimation residual was used as the stealthiness metric in [10A], [14A]. [28A] used a critical measurement, such as the sum of the water levels in a water tank system, as the effectiveness metric. The present example can use any of these metrics, and/or allow the system operator to select metrics and consider them as hyperparameters to the vulnerability analysis problem. Next, the study defines a vulnerable NCPS as follows.

Definition 1 (Vulnerable System). For the NCPS in (3), (5) and (6), let l₁: [symbol] ²→ [symbol] , l₂: [symbol] ²→ [symbol] be the corresponding Lipschitz effectiveness and stealthiness functionals respectively. Consider a vulnerability set

$$( {τ}_{E} , {τ}_{S} ) = \{ {e}_{u} ∈ {\sum }_{{k}_{u}} , {e}_{y} ∈ {\sum }_{{k}_{y}} \vert {l}_{1} ( {e}_{u} , {e}_{y} ) \geq {τ}_{E} , {l}_{2} ( {e}_{u} , {e}_{y} ) \leq {τ}_{S} \} ,$$

where τ_{E}, τ_{S} are the corresponding effectiveness and stealthiness thresholds. Then
1. The NCPS is said to be vulnerable if [symbol] (τ_{E}, τ_{S})∉Ø;
2. If [symbol] (τ_{E}, τ_{S})∉Ø, the attacks eᵤ, e_{y} are said to be feasible for given thresholds τ_{E} and τ_{S} if {eᵤ, e_{y}}∈ [symbol] (τ_{E}, τ_{S})

Specifying the l₁ and l₂ as Lipschitz functionals is justifiable as they are often given by energy-like functions expressed in terms of certain norms and/or inner products. This can be achieved by either employing a linear model approximation [29A] or utilizing data-driven universal approximation [15A].

To assess the vulnerability of the NCPS in (3), (5) and (6), which is equivalent to certifying the nonemptyness of [symbol] , it is sufficient to generate any feasible eᵤ, e_{y}. Therefore, the vulnerability analysis can be formulated as an attack generation problem [30A]. The study shows that the domain of [symbol] (τ_{E}, τ_{S}) is a function space, thereby rendering the attack generation problem infinite dimensional. To circumvent this, the study employs an attack policy, which is a parameterized basislike signal vector used as a heuristic to simplify the search space for the generative model. This essentially transforms the original infinite-dimensional search space into a finitedimensional parameter search. Next, the study formalizes this definition of attack policy.

Definition 2 (Attack Policy). An attack policy π(ϕ) is a mapping from policy parameter vector ϕ∈ [symbol] ⁿ^{_{ϕ}} to a deterministic time sequence of the injected attack vectors e.

Thus, this results in a more conservative vulnerability set

$$( {τ}_{E} , {τ}_{S} ) = \{ ϕ ∈ {ℝ}^{{n}_{ϕ}} \vert {l}_{1} ( π ( ϕ ) ) \geq {τ}_{E} , {l}_{2} ( π ( ϕ ) ) \leq {τ}_{S} \} \underline{⊂} ( {τ}_{E} , {τ}_{S} )$$

whose domain is a finite-dimensional Euclidean space. Consequently, to explore the set [symbol] (τ_{E}, τ_{S}), the study developed a generative model for the parameters of the attack policy such that the resulting attack is feasible with a high probability.

Definition 3 (Generative model). A generative model is a mapping of the form

$$G ( z , θ ) : ( Ω , , {P}_{z} ) \times {ℝ}^{{n}_{θ}} \to {ℝ}^{{n}_{ϕ}} \qquad ( 15 )$$

with a tunable parameter vector θ∈ [symbol] ⁿ^{_{θ}} and a probability prior (Ω, [symbol] , P_{z}) with random variables z˜P_{z}, which satisfies

$$Pr \{ G ( z , θ ) ∈ \} \geq η \qquad ( 16 )$$

for a given η∈(0,1).
   Essentially, G(z, θ) is a generative model for the set [symbol] if G(z, θ)∈ [symbol] with a high probability given by the lower bound η. The attack policy is ultimately deployed together with a trained generative model. The effectiveness and stealthiness, measured by the functionals l₁ and l₂, are used to train the generative model. Therefore, the goal of training the generative model is to find any feasible parameter vector θ*_{g} which satisfies (16). The next results gives a sufficient condition for this requirement.

Theorem 1. Given a set [symbol] whose boundary is of measure zero. If

$$𝔼 [ D ( G ( z , θ ) ) ] \leq 1 - η \qquad ( 17 )$$

where D: [symbol] ⁿ^{_{ϕ}}→ [symbol] is a function which satisfies

$$D ( ϕ ) \{ \begin{matrix}∈ [ 0 , 1 ] & if ϕ ∈ \\ > 1 & otherwise\end{matrix} \qquad ( 18 )$$

then

$$Pr \{ G ( z , θ ) ∈ \} \geq η$$

Proof. By definition of the expectation operator, for any random variable x,¹

$$\begin{matrix}𝔼 [ D ( x ) ] = {\sum }_{X ∈ {ℝ}^{n}} D ( X ) Pr \{ x = X \} \\ = {\sum }_{X ∈ 𝒮} D ( X ) Pr \{ x = X \} + {\sum }_{X ∉ 𝒮} D ( X ) Pr \{ x = X \}\end{matrix}$$

Since D(x)≥0, it follows that

$$𝔼 [ D ( x ) ] \geq {\sum }_{X ∉ 𝒮} D ( X ) Pr \{ x = X \}$$

In addition, since D(x)>1 for all x∉ [symbol] , [symbol] [D(x)] can be further lower bounded as

$$𝔼 [ D ( x ) ] \geq {\sum }_{X ∉ 𝒮} Pr \{ x = X \} = Pr \{ x ∉ \}$$

Replacing x with G(z, θ) yields

[symbol]

[D(G(z,θ))]≥Pr{G(z,θ)∉ [symbol] }

Using the inequality in (17), it follows that

$$\begin{matrix}Pr \{ G ( z , θ ) ∈ 𝒮 \} = 1 - Pr \{ G ( z , θ ) ∉ \} \\ \geq 1 - 𝔼 [ D ( G ( z , θ ) ) ] \\ \geq 1 - ( 1 - η )\end{matrix}$$

$$\geq η$$

Consequently, for a given threshold η∈(0,1), the study defined the feasible parameter set Θ_{g}(η):

$${Θ}_{g}^{*} ( η ) {=}^{△} \{ {θ}_{g} ∈ {ℝ}^{{n}_{g}} \vert {𝔼}_{z \sim {P}_{z}} [ D ( G ( z , {θ}_{g} ) ) ] \leq 1 - η \}$$

By utilizing any function D which satisfies the discrimination property in (18), the nonconvex vulnerability analysis problem can be transformed to a training problem for the generative model G(z, θ). For this, the study considers the example loss function

$$J ( θ ) = ReLU ( {𝔼}_{z \sim {P}_{z}} [ D ( G ( z ; θ ) ) ] - ( 1 - η ) ) \qquad ( 20 )$$

Theorem 2. Given η∈(0,1), if Θ*_{g}(η) is nonempty, then

$${arg min}_{θ ∈ {ℝ}^{{n}_{g}}} J ( θ ) ⊆ {Θ}_{g}^{*} ( η )$$

Proof. Let

$${θ}^{*} ∈ {arg min}_{θ ∈ {ℝ}^{n} g} J ( θ ) .$$

Then, given any arbitrary θ₁∈ [symbol] ⁿ^{_{g}}, it follows from the optimality of θ* that

$$ReLU ( {𝔼}_{z \sim {P}_{z}} [ D ( G ( z ; {θ}^{*} ) ) ] - ( 1 - η ) ) \leq ReLU ( {𝔼}_{z \sim {P}_{z}} [ D ( G ( z ; {θ}_{1} ) ) ] - ( 1 - η ) )$$

Now, due to the order preservation of the ReLU function, either

$${θ}_{1} ∈ {arg min}_{θ ∈ {ℝ}^{{n}_{g}}} J ( θ ) or {𝔼}_{z \sim {P}_{z}} [ D ( G ( z ; {θ}^{*} ) ) ] \leq {𝔼}_{z \sim {P}_{z}} [ D ( G ( z ; {θ}_{1} ) ) ] \qquad ( 21 )$$

(21) holds for all

$${θ}_{1} ∉ {arg min}_{θ ∈ {ℝ}^{{n}_{g}}} J ( θ ) .$$

### Thus, for any

$${θ}_{g} ∈ {Θ}_{g}^{*} ( η ) \backslash {arg min}_{θ ∈ {ℝ}^{{n}_{g}}} J ( θ ) ,$$

it follows that

$${𝔼}_{z \sim {P}_{z}} [ D ( G ( z ; {θ}^{*} ) ) ] \leq {𝔼}_{z \sim {P}_{z}} [ D ( G ( z ; {θ}_{g} ) ) ] \leq 1 - η$$

which implies that θ*∈Θ*_{g}(θ). Thus far, the study has formulated the vulnerability analysis problem as an attack generation problem solved by training a generative network with a custom loss function. The next development focuses on the training algorithm and associated convergence properties.

### Results

The training convergence of the generative model with the loss function in (20), using the specific discrimination function of the form:

D(ϕ)=D̅(τ_{E},τ_{S},l₁∘π(ϕ),l₂∘π(ϕ))
where the function D̅ is Lipschitz in each argument with Lipschitz constants not bigger than L_{D}>0. The training process is shown schematically in FIG. 14.

First, the study analyzed the convergence guarantee when l₁, l₂ are known exactly. However, calculating the gradient of such a nonlinear networked dynamical system can be computationally expensive. As a result, the study used universal approximators to learn the functions l₁ and l₂ from runtime data. The study also shows that the convergence property is preserved using the approximated versions \hat{l}₁ and \hat{l}₂. To obtain a parameter vector within the feasible set Θ*_{g}(η), the study employed the iterative scheme:

$${θ}_{g}^{( i + 1 )} = {θ}_{g}^{( i )} - {λ}_{i} {h}^{( i )} \qquad ( 23 )$$

where h⁽ⁱ⁾∈∂J(θ_{g}⁽ⁱ⁾) is a subgradient of J at θ_{g}⁽ⁱ⁾ which satisfies the inequality

$$J ( θ ) \geq J ( {θ}_{g}^{( i )} ) + {h}^{( i ) ⊤} ( θ - {θ}_{g}^{( i )} ) \qquad ( 24 )$$

for all θ. Then, at each iterative step, the study set

$${J}_{best}^{( i + 1 )} = min \{ {J}_{best}^{( i )} , J ( {θ}_{g}^{( i + 1 )} ) \} \qquad ( 25 )$$

and I_{best}⁽ⁱ⁺¹⁾=i if J(θ_{g}⁽ⁱ⁺¹⁾)=J_{best}⁽ⁱ⁺¹⁾, otherwise I_{best}⁽ⁱ⁺¹⁾=I_{best}⁽ⁱ⁾. Accordingly, the study set the parameter estimate as

$${\hat{θ}}_{g}^{( i )} = {θ}_{g}^{( {I}_{best}^{( i )} )} .$$

Proposition 1. Suppose there exists a compact subsets Θ_{g}⊂ [symbol] ⁿ^{_{θ}}, Φ⊂ [symbol] ⁿ^{_{ϕ}}, and real constants L₁>0, L₂>0, L_{G}>0 such that the generative model G(z, θ) and the functions l₁∘π: [symbol] ⁿ^{_{ϕ}}→ [symbol] and l₂∘π: [symbol] ⁿ^{_{ϕ}}→ [symbol] satisfy the Lipschitz conditions:

$${𝔼}_{z \sim {P}_{z}} [ ‖ G ( z , {θ}_{1} ) - G ( z , {θ}_{2} ) ‖ ] \leq {L}_{G} ‖ {θ}_{1} - {θ}_{2} ‖ \qquad ( 26 )$$

$$\vert {l}_{1} ∘ π ( {ϕ}_{1} ) - {l}_{1} ∘ π ( {ϕ}_{2} ) \vert \leq {L}_{1} ‖ {ϕ}_{1} - {ϕ}_{2} ‖ \qquad ( 27 )$$

$$\vert {l}_{2} ∘ π ( {ϕ}_{1} ) - {l}_{2} ∘ π ( {ϕ}_{2} ) \vert \leq {L}_{2} ‖ {ϕ}_{1} - {ϕ}_{2} ‖ \qquad ( 28 )$$

for all θ₁, θ₂∈Θ_{g} and all ϕ₁, ϕ₂∈Φ. Then, the loss function in (20), with discrimination function D in (22), satisfies the Lipschitz condition

$$\vert J ( {θ}_{1} ) - J ( {θ}_{2} ) \vert \leq {L}_{D} ( {L}_{1} + {L}_{2} ) {L}_{G} ‖ {θ}_{1} - {θ}_{2} ‖ \qquad ( 29 )$$

for all θ₁, θ₂∈Θ_{g}.
   Proof. According to (26),

$${𝔼}_{z \sim {P}_{z}} [ G ( z , θ ) ]$$

is Lipschitz continuous. Thus, for any compact set Θ_{g}⊂ [symbol] ⁿ^{_{θ}}, the study set Φ as its image under

$${𝔼}_{z \sim {P}_{z}} [ G ( z , θ ) ] .$$

Thus, for all θ₁, θ₂∈Θ_{g}, the following follows from the Lipschitz continuity of the ReLU function

$$\vert J ( {θ}_{1} ) - J ( {θ}_{2} ) \vert \leq \vert {𝔼}_{z \sim {P}_{z}} [ D ( G ( z , {θ}_{1} ) ) ] - {𝔼}_{z \sim {P}_{z}} [ D ( G ( z , {θ}_{2} ) ) ] \vert \leq \vert {𝔼}_{z \sim {P}_{z}} [ D ( G ( z , {θ}_{1} ) ) - D ( G ( z , {θ}_{2} ) ) ] \vert$$

where the last inequality follows from the linearity of the expectation operator. Using the Jensen's inequality, and the conditions in (27) and (28), yields

$$\vert J ( {θ}_{1} ) - J ( {θ}_{2} ) \vert \leq {𝔼}_{z \sim {P}_{z}} [ \vert D ( G ( z , {θ}_{1} ) ) - D ( G ( z , {θ}_{2} ) ) \vert ] \leq {𝔼}_{z \sim {P}_{z}} [ {L}_{D} ( {L}_{1} + {L}_{2} ) ‖ G ( z , {θ}_{1} ) - G ( z , θ ) ‖ ] \leq {L}_{D} ( {L}_{1} + {L}_{2} ) {𝔼}_{z \sim {P}_{z}} [ ‖ G ( z , {θ}_{1} ) - G ( z , {θ}_{2} ) ‖ ] \leq {L}_{D} ( {L}_{1} + {L}_{2} ) {L}_{G} ‖ {θ}_{1} - {θ}_{2} ‖$$

Remark 2. As an example of (22), it is not hard to check that

$${D}_{s} ( ϕ ) = exp ( LeakyReLU ( {τ}_{E} - {l}_{1} ∘ π ( ϕ ) ; s )$$

satisfies the discrimination property in (18) for any s∈(0, 1). Also, Proposition 1 holds with L_{D}=e^{b}, where

$$b = {sup}_{ϕ ∈ 𝒮 ( {τ}_{E} , {τ}_{S} )} ( \vert {τ}_{E} - {l}_{1} ∘ π ( ϕ ) \vert + \vert {τ}_{s} - {l}_{2} ∘ π ( ϕ ) \vert )$$

Next, the study presents results on the asymptotic convergence of the scheme in (23).

Theorem 3. Consider a generative model G(z, θ_{g}) and discriminator D(ϕ) which satisfy the Lipschitz conditions in Proposition 1. Given any initial guess θ_{g}⁽⁰⁾∈Θ_{g}. Suppose that the feasible parameter set satisfies the inclusion Θ*_{g}(η)≤Θ_{g}, and that the step size sequence of the iterative scheme in (23) is chosen to satisfy the nonsummable square-summable property

$${\sum }_{i = 0}^{∞} {λ}_{i} = ∞ , {\sum }_{i = 0}^{∞} {λ}_{i}^{2} \leq M \qquad ( 31 )$$

for some real number M<∞. Then, for any ϵ>0,

$${J}_{best}^{( i )} - J ( {θ}_{g}^{*} ) \leq ϵ for all i \geq {N}_{ϵ} \qquad ( 32 )$$

$$where$$

$${N}_{ϵ} = min \{ i ∈ ℤ \vert {\sum }_{j = 0}^{i} {λ}_{j} \geq \frac{{‖ {θ}_{g}^{( 0 )} - {θ}_{g}^{*} ‖}^{2} + {{L}_{D}^{2} ( {L}_{1} + {L}_{2} )}^{2} {L}_{G}^{2} M}{2 ϵ} \} \qquad ( 33 )$$

$$and$$

$${θ}_{g}^{*} {=}^{△} {arg min}_{θ ∈ {Θ}_{g}^{*} ( η )} \{ ‖ {θ}_{g}^{( 0 )} - θ ‖ \}$$

is the projection of the initial guess to the feasible parameter set in (19), L_{D} and L_{G} are the Lipschitz constants given in (29).
   Proof. From (23) and (24),

$$\begin{matrix}{‖ {θ}_{g}^{( i + 1 )} - {θ}_{g}^{*} ‖}^{2} = {‖ {θ}_{g}^{( i )} - {λ}_{i} {h}^{( i )} - {θ}_{g}^{*} ‖}^{2} \\ = {‖ {θ}_{g}^{( i )} - {θ}_{g}^{*} ‖}^{2} - 2 {λ}_{i} {h}^{( i ) ⊤} ( {θ}_{g}^{( i )} - {θ}_{g}^{*} ) + {λ}_{i}^{2} {‖ {h}^{( i )} ‖}^{2} \leq \\ {‖ {θ}_{g}^{( i )} - {θ}_{g}^{*} ‖}^{2} - 2 {λ}_{i} [ J ( {θ}_{g}^{( i )} ) - J ( {θ}_{g}^{*} ) ] + {λ}_{i}^{2} {‖ {h}^{( i )} ‖}^{2}\end{matrix}$$

Iterating the last inequality over {0, . . . , i+1} yields

$${‖ {θ}_{g}^{( i + 1 )} - {θ}_{g}^{*} ‖}^{2} \leq {‖ {θ}_{g}^{( 0 )} - {θ}_{g}^{*} ‖}^{2} - 2 {\sum }_{j = 0}^{i} {λ}_{j} [ J ( {θ}_{g}^{( j )} ) - J ( {θ}_{g}^{*} ) ] + {\sum }_{j = 0}^{i} {λ}_{i}^{2} {‖ {h}^{( j )} ‖}^{2}$$

Since ∥θ_{g}⁽ⁱ⁺¹⁾−θ*_{g}∥²≥0, it follows that

$$2 {\sum }_{j = 0}^{i} {λ}_{j} [ J ( {θ}_{g}^{( j )} ) - J ( {θ}_{g}^{*} ) ] \leq {‖ {θ}_{g}^{( 0 )} - {θ}_{g}^{*} ‖}^{2} + {\sum }_{j = 0}^{i} {λ}_{i}^{2} {‖ {h}^{( j )} ‖}^{2} \qquad ( 34 )$$

On the other hand, the following inequalities hold

$${\sum }_{j = 0}^{i} {λ}_{j} [ J ( {θ}_{g}^{( j )} ) - J ( {θ}_{g}^{*} ) ] \geq ( {\sum }_{j = 0}^{i} {λ}_{j} ) {min}_{j = 1 , … , i} [ J ( {θ}_{g}^{( j )} ) - J ( {θ}_{g}^{*} ) ]$$

where (35) follows from (25) by noting that J_{best}⁽ⁱ⁾=min{J(θ_{g}⁽⁰⁾), . . . , J(θ_{g}⁽ⁱ⁾)}. Combining (34) and (35) yields:

$${J}_{best}^{( i )} - J ( {θ}_{g}^{*} ) \leq \frac{{‖ {θ}_{g}^{( 0 )} - {θ}_{g}^{*} ‖}^{2} + {\sum }_{j = 0}^{i} {λ}_{j}^{2} {‖ {h}^{( j )} ‖}^{2}}{2 {\sum }_{j = 0}^{i} {λ}_{j}}$$

From Proposition 1, it is seen that the loss function J(θ) is uniformly Lipschitz over Θ*_{g}(η) with the constant L_{D}(L₁+L₂)L_{G}. Thus, the subgradient h⁽ⁱ⁾ can be upper bounded as:

$${‖ {h}^{( i )} ‖}^{2} \leq {L}_{D} ( {L}_{1} + {L}_{2} ) {L}_{G} \qquad ( 36 )$$

leading to the inequality:

$${J}_{best}^{( i )} - J ( {θ}_{g}^{*} ) \leq \frac{{‖ {θ}_{g}^{( 0 )} - {θ}_{g}^{*} ‖}^{2} + {{L}_{D}^{2} ( {L}_{1} + {L}_{2} )}^{2} {L}_{G}^{2} {\sum }_{j = 0}^{i} {λ}_{j}^{2}}{2 {\sum }_{j = 0}^{i} {λ}_{j}} \leq \frac{{‖ {θ}_{g}^{( 0 )} - {θ}_{g}^{*} ‖}^{2} + {{L}_{D}^{2} ( {L}_{1} + {L}_{2} )}^{2} {L}_{G}^{2} M}{2 {\sum }_{j = 0}^{i} {λ}_{j}} \leq ϵ for all i \geq {N}_{ϵ}$$

Remark 3. Since ϵ is arbitrary and J⁽ⁱ⁾≥J(θ*), it follows that lim_{i→∞}J_{best}⁽ⁱ⁾=J(θ*), which according to the feasibility set defined in (19), implies that lim_{i→∞}θ_{g}⁽ⁱ⁾∈Θ_{g}(η) for any given η.

Next, to reduce the computational burden of the gradient evaluation, the study approximated the functions l₁∘π, l₂∘π using universal approximators and develop a corresponding training algorithm for the generative model. The two data-driven models \hat{l}₁, \hat{l}₂ are assumed to satisfy the universal approximation properties [31A], [32A]: For any ϵ₁, ϵ₂∈ [symbol] ₊, there exists parameter vectors β₁ and β₂ such that

$${sup}_{θ ∈ {Θ}_{g}} max \{ \vert {\hat{l}}_{1} ( θ ; {β}_{1} ) - {l}_{1} ∘ π ( θ ) \vert , ‖ {\hat{l}}_{1} - {l}_{1} ‖ \} \leq {ϵ}_{1}$$

where Iᵢ∈∂(l₁∘π(θ)) and Îᵢ∈∂\hat{l}₁(θ; βᵢ), i∈1,2 are respective subgradients of functions lᵢ∘π and their estimates \hat{l}ᵢ(θ; βᵢ). The inequalities in (37) are expressed (in Sobolev space) in terms of essential supremum norm up to the first weak derivative. This has been used extensively to study the approximation properties of deep neural networks [33A].

Corollary 3.1 (Convergence with Approximated \hat{l}₁, \hat{l}₂). Suppose the data-driven models \hat{l}₁(θ_{E}⁽ⁱ⁾), \hat{l}₂(θ_{S}⁽ⁱ⁾) satisfy the universal approximation properties in (37), where θ_{E}⁽ⁱ⁾ and θ_{S}⁽ⁱ⁾ are optimal parameters at epoch i. Then, by following Algorithm 1 with the nonsummable square-summable property in (31), for any ϵ>0,

$${J}_{b e s t}^{( i )} - J ( {θ}_{g}^{★} ) \leq ϵ for all i \geq {\overline{N}}_{ϵ}$$

$$where$$

$${\overline{N}}_{ϵ} = min \{ i ∈ ℤ \vert {\sum }_{j = {N}_{ϵ} + 1}^{i} {λ}_{j} \geq \frac{{L}_{D}^{2} ( {L}_{1} + {L}_{2} + \frac{{ϵ}_{1} + {ϵ}_{2}}{2 {d}_{g}} ) ( \frac{{ϵ}_{1} + {ϵ}_{2}}{{d}_{g}} ) {L}_{G}^{2} M}{ϵ} \} ,$$

and N_{ϵ} is the constant given in (33).

Proof. Using the data-driven models \hat{l}₁ and \hat{l}₂, the iterative scheme becomes

$${θ}_{g}^{( i + 1 )} = {θ}_{g}^{( i )} - {λ}_{i} {\hat{h}}^{( i )}$$

where ĥ⁽ⁱ⁾∈∂Ĵ(θ_{g}⁽ⁱ⁾) is an estimation of the subgradient of the objective function evaluated using the approximate datadriven models. Here, the resulting estimated objective function is

$$\hat{J} ( θ ) = ReLU ( {𝔼}_{z \sim {P}_{z}} [ \hat{D} ( G ( z ; θ ) ) ] - ( 1 - η ) )$$

where \hat{D}(ϕ)=D̅(τ_{E}, τ_{S}, \hat{l}₁(ϕ), \hat{l}₂(ϕ)). Consequently, as a direct consequence of Proposition 1 and the universal approximation properties in (37), it is straightforward to show that Ĵ satisfies the Lipschitz inequality

$$\vert \hat{J} ( {θ}_{1} ) - \hat{J} ( {θ}_{2} ) \vert \leq {L}_{D} ( {L}_{1} + {L}_{2} + \frac{{ϵ}_{1} + {ϵ}_{2}}{{d}_{g}} ) {L}_{G} ‖ {θ}_{1} - {θ}_{2} ‖ \qquad ( 40 )$$

for all θ₁, θ₂∈Θ_{g}, where d_{g} [symbol] max_{θ}_{₁}_{,θ}_{₂}_{∈Θ}_{_{g}}∥θ₁−θ₂∥ is the diameter of the compact set Θ_{g}. Following similar arguments as in the proof of Theorem 3,

$$\begin{matrix}{‖ {θ}_{g}^{( i + 1 )} - {θ}_{g}^{★} ‖}^{2} = {‖ {θ}_{g}^{( i )} - {λ}_{i} {\hat{h}}^{( i )} - {θ}_{g}^{★} ‖}^{2} \\ \leq {‖ {θ}_{g}^{( i )} - {θ}_{g}^{★} ‖}^{2} - 2 {λ}_{i} [ J ( {θ}_{g}^{( i )} ) - J ( {θ}_{g}^{★} ) ] + {λ}_{i}^{2} {‖ {\hat{h}}^{( i )} ‖}^{2}\end{matrix} \qquad ( 41 )$$

$$Thus ,$$

$$\begin{matrix}{\hat{J}}_{b e s t}^{( i )} - J ( {θ}_{g}^{★} ) \leq \frac{{{‖ {θ}_{g}^{( 0 )} - {θ}_{g}^{★} ‖}^{2} + {\sum }_{j = 0}^{i} {λ}_{j}^{2} ‖ {\hat{h}}^{( j )} ‖}^{2}}{2 {\sum }_{j = 0}^{i} {λ}_{j}} \\ \leq \frac{{‖ {θ}_{g}^{( 0 )} - {θ}_{g}^{★} ‖}^{2} + {{L}_{D}^{2} ( {L}_{1} + {L}_{2} + \frac{{ϵ}_{1} + {ϵ}_{2}}{{d}_{g}} )}^{2} {L}_{G}^{2} M}{2 {\sum }_{j = 0}^{i} {λ}_{j}} \\ \leq \frac{{‖ {θ}_{g}^{( 0 )} - {θ}_{g}^{★} ‖}^{2} + {{L}_{D}^{2} ( {L}_{1} + {L}_{2} )}^{2} {L}_{G}^{2} M}{2 {\sum }_{j = 0}^{i} {λ}_{j}} + \frac{{L}_{D}^{2} ( 2 {L}_{1} + 2 {L}_{2} + \frac{{ϵ}_{1} + {ϵ}_{2}}{{d}_{g}} ) ( \frac{{ϵ}_{1} + {ϵ}_{2}}{{d}_{g}} ) {L}_{G}^{2} M}{2 {\sum }_{j = 0}^{i} {λ}_{j}} \\ \leq ϵ for all i \geq {\hat{N}}_{ϵ}\end{matrix}$$

$$Where :$$

$${\hat{N}}_{ϵ} = min \{ i ∈ ℤ \vert {\sum }_{j = 0}^{i} {λ}_{j} \geq a + b \}$$

$$With :$$

$$a = \frac{{‖ {θ}_{g}^{( 0 )} - {θ}_{g}^{★} ‖}^{2} + {{L}_{D}^{2} ( {L}_{1} + {L}_{2} )}^{2} {L}_{G}^{2} M}{2 ϵ}$$

$$b = \frac{{L}_{D}^{2} ( 2 {L}_{1} + 2 {L}_{2} + \frac{{ϵ}_{1} + {ϵ}_{2}}{{d}_{g}} ) ( \frac{{ϵ}_{1} + {ϵ}_{2}}{{d}_{g}} ) {L}_{G}^{2} M}{2 ϵ}$$

$$From ( 33 ) , {N}_{ϵ} = min \{ i ∈ ℤ \vert {\sum }_{j = 0}^{i} {λ}_{j} \geq a \} . Thus$$

$$\begin{matrix}{\hat{N}}_{ϵ} = min \{ i ∈ ℤ \vert {\sum }_{j = 0}^{i} {λ}_{j} - {\sum }_{j = 0}^{{N}_{ϵ}} {λ}_{j} \geq a - {\sum }_{j = 0}^{{N}_{ϵ}} {λ}_{j} + b \} \\ = min \{ i ∈ ℤ \vert {\sum }_{j = {N}_{ϵ} + 1}^{i} {λ}_{j} \geq a - {\sum }_{j = 0}^{{N}_{ϵ}} {λ}_{j} + b \}\end{matrix}$$

$$Since {\sum }_{j = 0}^{{N}_{ϵ}} {λ}_{j} \geq a , it follows that {\hat{N}}_{ϵ} \leq min \{ i ∈ ℤ \vert {\sum }_{j = {N}_{ϵ} + 1}^{i} {λ}_{j} \geq b \} = {\overline{N}}_{ϵ}$$

Essentially, the above theorem shows that, with the uncertainties on the l₁, l₂ functions, the feasible set Θ*_{g}(η) can still be reached but with a particular amount of increased convergence time. The increase in the convergence time depends on the choice of step size and the uncertainty bounds.

### Example Case Studies

The example implementation included case studies for a power grid system and gas pipeline network. The case studies included attack policies that can be used in implementations of the present disclosure.

The study considered a structure of attack policy as:

$$π ( {θ}_{a} ) = \{ {t}_{0} ( {θ}_{a} ) , T ( {θ}_{a} ) , e ( {θ}_{a} , t ) \} \qquad ( 42 )$$

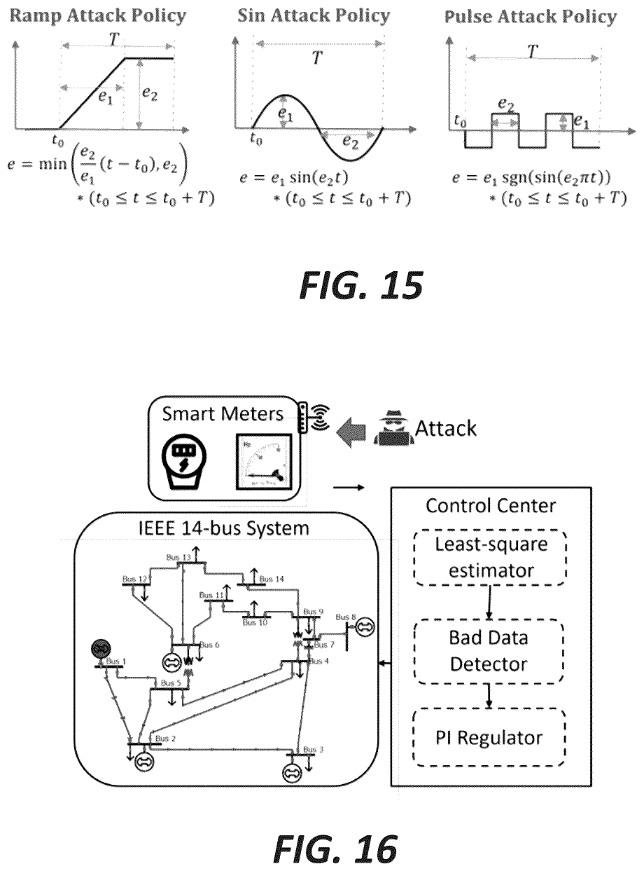

It includes the start time of the attack injection t₀∈[tₗ, tᵤ], the duration of the attack injection T∈[Tₗ, Tᵤ], and the attack profile e(θₐ, t). [tₗ, tᵤ] and [Tₗ, Tᵤ] are the pre-defined interval of the start time and duration of the attack injection respectively. Examples of such attack policies can be found in FIG. 15, such as ramp attack (RA), sine attack (SA), and pulse attack (PA).

The attack injection time t₀ and the duration time T are determined as

$${t}_{0} = {t}_{l} + {θ}_{a 1} ( {t}_{u} - {t}_{l} ) \qquad ( 43 )$$

$$T = {T}_{l} + {θ}_{a 2} ( {t}_{u} - {t}_{l} ) \qquad ( 43 )$$

The attack profile functions are determined by two parameters e₁∈[e₁, ē₁], e₂∈[e₂, ē₂], where [e₁, ē₁] and [e₂, ē₂] are also
the pre-defined intervals. The value of e₁, e₂ are determined by the output of the generator θₐ:

$${e}_{1} = {\underline{e}}_{1} + {θ}_{a 3} ( {\overline{e}}_{1} - {\underline{e}}_{1} ) \qquad ( 44 )$$

$${e}_{2} = {\underline{e}}_{2} + {θ}_{a 4} ( {\overline{e}}_{2} - {\underline{e}}_{2} ) \qquad ( 44 )$$

Then, for RA policy, the attack profile function is given as:

$${e}_{R A} ( {θ}_{a} , t ) = min \{ \frac{{e}_{2}}{{e}_{1}} ( t - {t}_{0} ) , {e}_{2} \} ⊙ ( {t}_{0} \leq t \leq {t}_{0} + T ) \qquad ( 45 )$$

For SA policy, it is given as

$${e}_{S A} ( {θ}_{a} , t ) = {e}_{1} sin ( {e}_{2} t ) ⊙ ( {t}_{0} \leq t \leq {t}_{0} + T ) \qquad ( 46 )$$

For PA policy, it is given as

$${e}_{P A} ( {θ}_{a} , j ) = {e}_{1} sgn ( sin ( {e}_{2} π t ) ) ⊙ ( {t}_{0} \leq t \leq {t}_{0} + T ) \qquad ( 47 )$$

### Power Grid

The study considered a power grid system comprising n_{g} generator buses and nₗ load buses. An example on IEEE 14-bus system (n_{g}=5, nₗ=14) is used, as shown in FIG. 16. The system is equipped with IoT net meters and frequency meters that measure the net power of buses and generators' frequency. A control center collects the sensor readings through a communication network and performs state estimation, bad data detection, and regulation control of the generator's rotor angles and frequency. However, an attacker could potentially compromise the communication channels or spoof the smart meters to tamper with the sensor readings received by the control center. This can result in a malicious modification of the power grid's state, causing unexpected damages.

The study included an example system's dynamical models and the nominal control setup. Without loss of generality, several assumptions are admitted [34A]:
1. The network voltages stay constant at v=1 p.u.;
2. The angular difference between each bus is small;
3. The conductance is negligible, therefore the system is lossless. The active power flow dynamics at bus i is represented as

$$0 = - {b}_{i j} sin ( {θ}_{i} - {θ}_{j} ) - {P}_{i} ( θ ) \qquad ( 48 )$$

where θᵢ denotes i-th bus angle, Pᵢ denotes the active power at the bus i, and bᵢⱼ is the associated susceptance of the transmission line between node i and node j. Then, given Ψ(θ) defined as in (2) with ψ(θᵢ, θⱼ)=−bᵢⱼ sin(θᵢ−θⱼ), the networked power flow dynamics is described by

$$0 = ( A ⊙ Ψ ( θ ) ) 1 - P ( θ ) \qquad ( 49 )$$

where the network power active power vector can be written as

$$P ( θ ) = [ \begin{matrix}{P}_{g}^{n ω} ( θ ) \\ {P}_{l}^{n ω} ( θ )\end{matrix} ] ,$$

and P_{g}^{nω}(θ), Pₗ^{nω}(θ) are the active power vector at generator buses and load buses, respectively. Furthermore, the nonlinear swing dynamics of generators is described by [34A]:

$$[ \begin{matrix}I & 0 \\ 0 & {M}_{g}\end{matrix} ] [ \begin{matrix}\dot{δ} \\ \dot{ω}\end{matrix} ] = [ \begin{matrix}0 & I \\ 0 & - {D}_{g}\end{matrix} ] [ \begin{matrix}δ \\ ω\end{matrix} ] + [ \begin{matrix}0 \\ {P}_{g} - {P}_{g}^{n ω} ( θ )\end{matrix} ] , \qquad ( 50 )$$

where δ∈ [symbol] ⁿ^{_{g}} is the vector of generator rotor angles, ω∈ [symbol] ⁿ^{_{g}} is the generator frequency vector, M_{g} is a diagonal matrix of inertial constants for each generator and D_{g} is a diagonal matrix of damping coefficients and P_{g}∈ [symbol] ⁿ^{_{g}} contains net power injected at the generator buses. In addition, at load buses, the active power Pₗ^{nω}(θ) is equal to the injected power Pₗ, so that

$${P}_{l}^{n ω} ( θ ) = {P}_{l} \qquad ( 51 )$$

Since the network power dynamics has already been at its steady state, the supervisory controller in (11) is not required, and the reference active power for generators can be determined as

$$P ( θ ) = ( A ⊙ Ψ ( θ ) ) 1 \qquad ( 52 )$$

By ordering the buses such that the generator nodes appear first, and linearizing the model in (52), the study obtained:

$$[ \begin{matrix}{P}_{g}^{n ω} ( θ ) \\ {P}_{l}^{n ω} ( θ )\end{matrix} ] = - L θ \qquad ( 53 )$$

where the admittance-weighted Laplacian matrix is given by as

$$L = [ \begin{matrix}{L}_{gg} & {L}_{lg} \\ {L}_{gl} & {L}_{l l}\end{matrix} ] ∈ {ℝ}^{N \times N} , N = {n}_{g} + {n}_{l} , and θ = [ \begin{matrix}δ \\ {θ}_{l}\end{matrix} ]$$

in which θₗ is the bus angle of load buses. Combining (51) and (53) yields

$${θ}_{l} = - {L}_{l l}^{- 1} ( {L}_{l g} δ - {P}_{l} ) \qquad ( 54 )$$

$$thus ,$$

$${P}_{g}^{n ω} ( θ ) = - {L}_{gg} δ - {L}_{l g} {θ}_{l}$$

Then substituting (55) into the generator dynamical equation (50) yields

$$\dot{x} = {\underbrace{[ \begin{matrix}0 & I \\ - {M}_{g}^{- 1} ( {L}_{gg} - {L}_{gl} {L}_{ll}^{- 1} {L}_{lg} ) & {M}_{g}^{- 1} {D}_{g}\end{matrix} ]}}_{{A}^{′}} x + {\underbrace{[ \begin{matrix}0 & 0 \\ {M}_{g}^{- 1} & - {M}_{g}^{- 1} {L}_{gl} {L}_{ll}^{- 1}\end{matrix} ]}}_{B} u \qquad ( 56 )$$

where the state variables x=[δ^{T}ω^{T}]^{T}∈ [symbol] ²ⁿ^{_{g}} contain the generator rotor angles and the generator frequency. The control input vector u=[P_{g}^{T} Pₗ^{T}]^{T}∈ [symbol] ⁿ^{_{g}}⁺ⁿ^{ₗ} contains the power injected at the generator buses and load buses. The study assumes the generator frequency and the net power at load buses are measured, then the following measurement model is utilized:

$$y = {\underbrace{[ \begin{matrix}0 & I \\ - P ( θ ) {L}_{ll}^{- 1} {L}_{lg} & 0\end{matrix} ]}}_{C} x + {\underbrace{[ \begin{matrix}0 & 0 \\ P ( θ ) {L}_{ll}^{- 1} & 0\end{matrix} ]}}_{D} u \qquad ( 57 )$$

where y=[ω^{T} Pₙₑₜ^{T}]^{T}∈ [symbol] ⁿ^{_{g}}⁺ⁿ^{ₗ} contain the generator frequency and the net power injected at the load buses. With a sample time Tₛ=0.01 s, the study obtained the discrete-time model of (56) and (57):

$$x ( k + 1 ) = {A}_{d} x ( k ) + {B}_{d} u ( k )$$

where A_{d}=A′Tₛ−I and B_{d}=BTₛ. A Luenberger observer is employed to estimate the states x(k+1) based on the discrete model in (58):

$$\hat{x} ( k + 1 ) = {A}_{d} \hat{x} ( k ) + {B}_{d} u ( k ) + L ( y ( k ) - C \hat{x} ( k ) - D u ( k ) ) ,$$

where L is the observer gain satisfying that A_{d}−LC has all the eigenvalues inside the unit circle.

Then the PI controller:

$$u ( k ) = {K}_{P} \tilde{x} ( k ) + {K}_{I} {\int }_{0}^{k} \tilde{x} ( τ ) d τ \qquad ( 60 )$$

is used to regulate the generators' rotor angles and frequencies. Namely, select gain matrices K_{I} and Kₚ to render the matrix

$$\begin{matrix}0 & I \\ {BK}_{I} & {A}^{′} + {BK}_{P}\end{matrix} ]$$

### Hurwitz.

Next, the study discussed the implementation of the proposed attack generator on this IEEE 14-bus system. The attacks are injected through the measurements. The total simulation time is set as 8 s, thereby Tₛᵢₘ=8/Tₛ=800 time steps in total. The study choose the ratio of the mean control error of the generator rotor angles to the maximum nominal³ generator angles to be the effectiveness index

$${a}_{E} = {l}_{1} ( e ) = \frac{\frac{1}{{T}_{s i m}} {\sum }_{k = 0}^{{T}_{sim}} {‖ δ ( k ) - {δ}^{r} ( k ) ‖}_{2}}{{max}_{0 \leq k \leq {T}_{sim}} {‖ {δ}_{nominal} ( k ) ‖}_{2}} \qquad ( 61 )$$

and choose the maximum estimation residual to be the stealthiness index

$${a}_{S} = {l}_{2} ( e ) = {max}_{0 \leq k \leq {T}_{sim}} {‖ y ( k ) - D u ( k ) - C \hat{x} ( k ) ‖}_{2} \qquad ( 62 )$$

The three attack policies, shown in FIG. 15, are all tested. The study used the same pre-defined range of start time and duration time of the attack injection t₀∈[0.1 Tₛᵢₘ, 0.2 Tₛᵢₘ], T∈[1e-5, Tₛᵢₘ]. The study choose e₁∈[0.1 Tₛᵢₘ, 0.6 Tₛᵢₘ], e₂∈[−0.04, 0.04] for ramp attack policy, e₁∈[−0.04,0.04], e₂∈[−5,5] for sine attack policy, e₁∈[−0.04,0.04], e₂∈[−5,5] for pulse attack policy. The generator has 4 layers, namely ReLU, ReLU, Tanh, and Sigmoid with 500, 1000, 500 and 4*(n_{g}+nₗ) neurons respectively, respectively. The stealth net includes of 3 ReLU hidden layers and a Sigmoid output layer. The effect net includes of 3 ReLU hidden layers and a Linear output layer. Both the effect net and stealth net have 500, 1000, and 500 neurons at the hidden layers. During each training epoch, they were trained in 20 batches with a size of 2000, and the generator was trained in 10 batches with a size of 5000.

All three attack policies are used separately in the training process of Algorithm 1 shown in FIG. 3B. Algorithm 1 Training generative model with data-driven \hat{l}₁, \hat{l}₂ Hyperparameters: τ_{E} (effectiveness threshold), τ_{S} (stealthiness threshold), η (success probability), π (attack policy), s (scale factor of leakyReLU function), P_{z} (prior distribution, i.e. uniform distribution), Nₛₐₘₚₗₑ (number of sample points for each epoch), N_{epoch} (total number of epochs for the training)

The same stealthiness and effectiveness thresholds are chosen: ϵ=0.05 and α=49%, so the feasible attack set is defined as

$$= ( 0.05 , 49 \% ) = \{ e \vert {l}_{1} ( e ) \geq 49 \% , {l}_{2} ( e ) \leq 0.05 \} \qquad ( 63 )$$

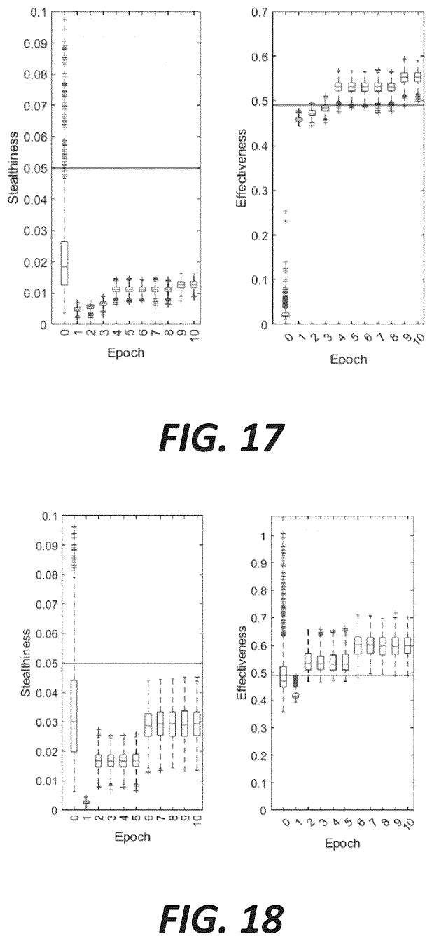

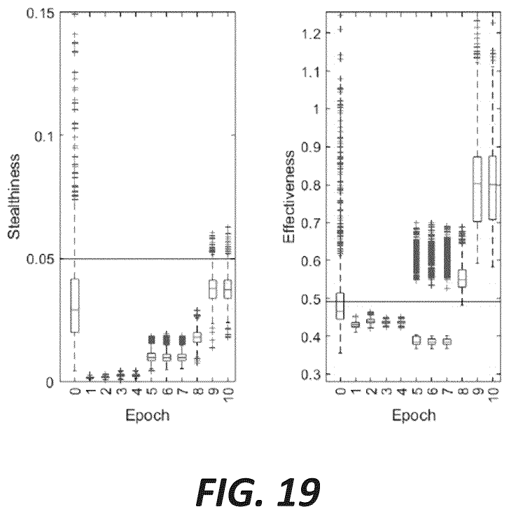

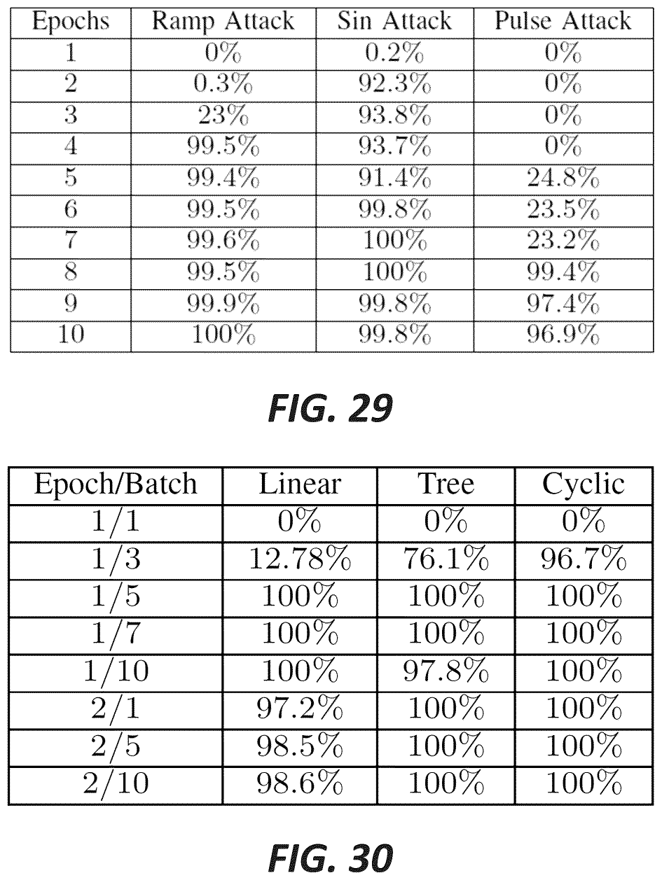

For Algorithm 1, other hyperparameters are chosen as η=0.8 and s=0. FIG. 17, FIG. 18, and FIG. 19 depict the testing results of the trained attack generator in the system simulation after each epoch for the three attack policies. These results indicate the successful training of the attack generation framework. Initially, most of the generated attacks could be detected and could not arouse effect. So the generator tried to decrease the stealthiness, but doing so also affected the effectiveness because of the positive correlation between the two metrics. Once the stealthiness went below the threshold, the generator began exploring more effective attacks until the effectiveness exceeded the given threshold. By comparing the testing performance policy-wise, it is seen that the attack generation framework approached the boundary of stealthiness more and achieved bigger effectiveness with the SA and PA policies compared to the RA policy. This finding implies that SA and PA policies enable more vulnerability space, which the attack generation framework could explore, than the RA policy. Additionally, FIG. 29 presents the corresponding testing scores, which indicate the ratio of feasible attacks in [symbol] (0.05, 49%) to the total testing samples for the epochs. It shows that the generator with SA policy converges faster than the other two, and the generator with PA policy is the slowest, likely due to its complexity.

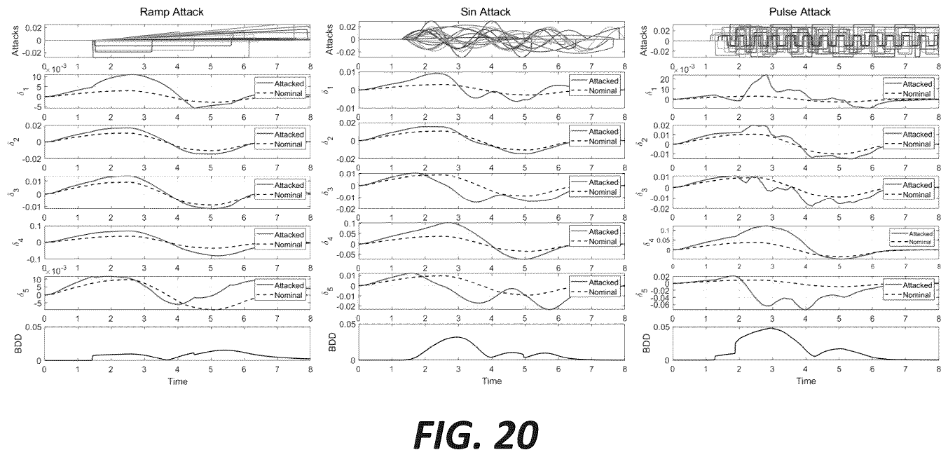

Next, the study evaluated the performance of the generated attacks with different attack policies by injecting them into the system's time-series simulation. As shown in FIG. 29, the study used the trained attack generators at epoch 10 for RA policy and epoch 8 for SA and PA policies. The examples of the time-series performance of the generated attacks are shown in FIG. 20. The first row displays the attack signals generated by the trained attack generators for all 19 sensors. The second to sixth rows show the comparison of generator rotor angles before and after the attack injection. The last row shows the outputted estimation residual (stealthiness index) by BDD. The results show that the proposed attack generation framework with PA policy could explore the most vulnerable space of the system since the largest BDD outputs touch the detection boundary during the simulation. Furthermore, different attack policies produce different effects on the system. RA policy introduces a constant bias on sensor readings, and thus the shapes of the attacked rotor angles are similar to the nominal ones. SA policy introduces waves in the rotor angles, while PA policy introduces higher-frequency fluctuations in rotor angles. Nonetheless, the proposed attack generation framework can find the corresponding feasible attack set for any attack policy.

### Gas Pipeline

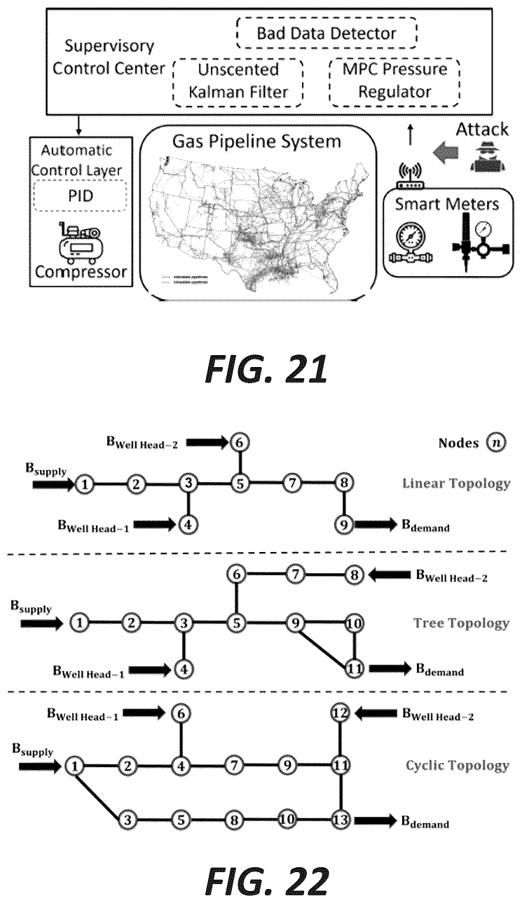

The study further considered gas pipeline systems equipped with IoT sensors and actuators, a supervisory controller, and automatic controllers, as shown in FIG. 21.

A nonlinear creep flow model is used to describe the gas flow in a pipeline segment [35A]:

$$\frac{\partial p}{\partial t} = - \frac{{c}^{2} ρ}{G} \cdot \frac{\partial {Q}_{n}}{\partial x}$$

where p is the pressure in the pipeline, x is the position of flow, c is the speed of sound in gas [m/s], ρ is the average gas density over the cross-section area of the pipeline [kg/m³], Qₙ is the volumetric flow at standard conditions, f is the friction factor, D is the diameter of the pipeline and G=π(D/2)². While the partial differential equation (PDE) model provides an accurate description of the gas flow dynamics for infrequent online optimization, an ordinary differential equation (ODE) model is sufficient to describe the pressure dynamics at nodes [35A]. The dynamical pressure model at node i is given as

$${\dot{p}}_{i} = \frac{{c}^{2}}{{V}_{i}} {\sum }_{j ∈ {𝒩}_{i}} \sqrt{\frac{\vert {p}_{j}^{2} - {p}_{i}^{2} \vert}{{K}_{i j}}} sgn ( {p}_{j} - {p}_{i} ) - {w}_{i} \qquad ( 65 )$$

where pᵢ is the pressure at node i, Nᵢ denote the set of neighborhood pipelines of node i,

$${K}_{ij} = \frac{64 {f}_{ij} {c}^{2} Δ {x}_{ij}}{{π}^{2} {D}_{ij}^{5}} ,$$

$${V}_{i} = \frac{π}{8} {\sum }_{j ∈ {N}_{i}} {D}_{ij}^{2} Δ {x}_{ij}$$

and wᵢ is the mass flow at node i, Δxᵢⱼ denotes the length of pipeline between node i and node j. Here,

$$ψ ( {p}_{i} , {p}_{j} ) = \sqrt{\frac{\vert {p}_{j}^{2} - {p}_{i}^{2} \vert}{{K}_{ij}}} sgn ( {p}_{j} - {p}_{i} ) \qquad ( 66 )$$

then the model of the entire pipeline network is given by

$$\dot{p} = {c}^{2} {V}^{- 1} ( A ⊙ Ψ ( p ) ) 1 - w$$

where Ψ(θ) is defined as in (2) with ψ(θᵢ, θⱼ) defined in (66), V⁻¹=diag([V₁⁻¹, V₂⁻¹, . . . , Vₙ⁻¹]), wₛᵤₚ is a vector of mass inflows at the supply points and w_{dem} is a vector of mass outflows at the demand points. Clearly w=−Bₛᵤₚwₛᵤₚ+B_{dem}w_{dem}, where B_{dem} and Bₛᵤₚ are appropriately dimensioned matrices such that Bₛᵤₚ^{T}B_{dem}=0 and P[−Bₛᵤₚ|B_{dem}]=I for some projection matrix P.

In addition, a dynamical model of the compressor between two nodes i and j is given by [36A]:

$${\dot{ω}}_{ij} = \frac{1}{{J}_{{o}_{i}}} ( {u}_{ij} + ρ {r}_{2}^{2} {q}_{ij} {ω}_{ij} )$$

$${\dot{w}}_{ij} = {q}_{ij}$$

$$where$$

$$ϕ ( ω , q ) = {( 1 + \frac{1}{{T}_{in} {c}_{p} 1000} ( ρ {r}_{2}^{2} {ω}^{2} + {k}_{f} {q}^{2} - \frac{{r}_{1}^{2}}{2} {( ω - \frac{q}{{A}_{c} {r}_{1} {ρ}_{in}} )}^{2} ) )}^{\frac{γ}{γ - 1}} ,$$

ωᵢⱼ is the compressor rotor angular velocity [rad/s], qᵢⱼ is the mass power flow [kg/s], ϕ(ω, q) is the compressor characterization, uᵢⱼ is the mechanical torque [N-m] applied to the rotor shaft or inertia J₀_{ᵢ} [kg-m²]. pᵢ and pⱼ are the input and output pressures of the compressor, respectively. For the system considered, the compressors are at the extremes of the network. Thus, at each compressor node, one of pᵢ and pⱼ will be the ambient pressure. pᵢ=P_{amb} for upstream compressors, while pⱼ=P_{amb} for downstream compressors. The compressor could be controlled by a simple PID controller:

$${u}_{ij} = {K}_{P} {\tilde{w}}_{ij} ( t ) + {K}_{I} {\int }_{0}^{t} {\tilde{w}}_{ij} ( τ ) d τ + {K}_{D} \frac{d {\tilde{w}}_{ij} ( t )}{dt} \qquad ( 69 )$$

where \tilde{w}ᵢⱼ(t)=wᵢⱼ−wᵢⱼ^{r}. Similarly, the PID gains K_{P}, K_{I}, K_{D} are designed to achieve the closed-loop performance in (7). Linearizing the models (67) around the equilibrium point (p_{eq}, w_{eq}) and discretizing with a fixed time step Tₛ=0.01 s yields

$${\tilde{p}}_{k + 1} = {A}_{d} {\tilde{p}}_{k} + {B}_{d} {\tilde{w}}_{k} \qquad ( 70 )$$

where \tilde{p}ₖ=pₖ−p_{eq}, \tilde{w}ₖ=wₖ−w_{eq}, and A_{d}, B_{d} are given as in (10) with

$$\frac{\partial ψ ( {p}_{i} , {p}_{j} )}{{\partial }_{{p}_{i}}} = - \frac{{p}_{i}}{{K}_{ij}} \sqrt{\frac{{K}_{ij}}{\vert {p}_{j}^{2} - {p}_{i}^{2} \vert}} sgn ( {p}_{j} - {p}_{i} ) sgn ( {p}_{j}^{2} - {p}_{i}^{2} ) , \frac{\partial ψ ( {p}_{i} , {p}_{j} )}{{\partial }_{{p}_{j}}} = \frac{{p}_{i}}{{K}_{ij}} \sqrt{\frac{{K}_{ij}}{\vert {p}_{j}^{2} - {p}_{i}^{2} \vert}} sgn ( {p}_{j} - {p}_{i} ) sgn ( {p}_{j}^{2} - {p}_{i}^{2} ) .$$

The supervisory target generator is given in (11) to regulate the node pressures around its equilibrium point at a lower frequency. The study assumed all node pressures and mass flows could be directly measured subject to noise v:

$$y = {x}^{′} + v \qquad ( 71 )$$

$$where$$

$${x}^{′} {=}^{△} [ \begin{matrix}p \\ {w}_{sup} \\ {w}_{dem}\end{matrix} ]$$

composes of the node pressure states, the wellhead supplied mass flow and the demand mass flow. An unscented Kalman filter (UKF) [37A] is used to estimate the states from the noisy measurements. The study tested three different pipeline systems with distinct network topologies, namely the Linear topology, Tree topology, and Cyclic topology, as illustrated in FIG. 22 [38A]. The linear topology example includes 9 nodes, the tree topology has 11 nodes and the cyclic topology has 13 nodes. All three pipeline systems have two gas supply wellheads, one demand node, and one supply node that requires control.

Next, the study discusses the implementation of the proposed attack generation system in these pipeline systems. The attacks are injected through the measurements, then the measurement model in (71) becomes

$$y = {x}^{′} + v + e \qquad ( 72 )$$

The total simulation time is set as 200 s, thereby Tₛᵢₘ=200/Tₛ=20000 time steps in total. To train the attack generator, the example implementation used the ratio of the mean value of the node pressure control error to a constant nominal pressure as the effectiveness metric:

$${a}_{E} = {l}_{1} ( e ) = \frac{1}{{T}_{sim}} {\sum }_{k = 0}^{{T}_{sim}} {‖ \tilde{p} ( k ) ‖}_{2} \qquad ( 73 )$$

and use the maximal estimation residual as the stealthiness metric:

$${a}_{S} = {l}_{2} ( e ) = {max}_{0 \leq k \leq {T}_{sim}} {‖ y ( k ) - {x}^{′} ( k ) ‖}_{2} \qquad ( 74 )$$

This case study focused on testing the Ramp attack policy, as defined in (45), with the pre-defined range of injection start time t₀∈[0.1 Tₛᵢₘ, 0.2 Tₛᵢₘ], injection duration time T∈[1e-5, 0.5 Tₛᵢₘ] and two attack value function parameters e₁∈[0.1 Tₛᵢₘ, Tₛᵢₘ] and e₂∈[0,0.5*y]. The input of the attack value function (45) is given in (43), where the input of the attack policy g is the output of the generator. For linear topological pipeline system, it has 12 measurements, so the output size of the associated generator is 4*12=48. Similarly, the output size of the generator for the tree topological pipeline system is 4*14=56 and the output size of the generator for the cyclic topological pipeline system is 4*16=64. The input sizes of the generators are the same and equal to 10, and they all have 4 layers: ReLU (500 neurons), Re LU (1000 neurons), Tanh (500 neurons), Sigmoid. The stealth net includes of 3 ReLU hidden layers and a Sigmoid output layer, and the effect net includes of 3 ReLU hidden layers and a Linear output layer. The numbers of neurons at hidden layers are 500, 1000, 500 for both the effect net and stealth net. In each training epoch, the discriminators are trained in 20 batches with a size of 1000, and the generator is trained in 5 batches with a size of 5000. The same stealthiness and effectiveness thresholds are chosen for all three topological pipeline systems: ϵ=0.02 and α=65, so the feasible attack set is defined as:

$$= ( 0.05 , 65 \% ) = \{ e \vert {l}_{1} ( e ) \geq 65 \% , {l}_{2} ( e ) \leq 0.05 \} \qquad ( 75 )$$

For Algorithm 1, other hyperparameters are chosen as η=0.8 and s=0. All generators converge in the first 2 epochs. Therefore, in order to show the convergence process of the generative system, the study plotted the testing results after each batch of training in the first 2 epochs.

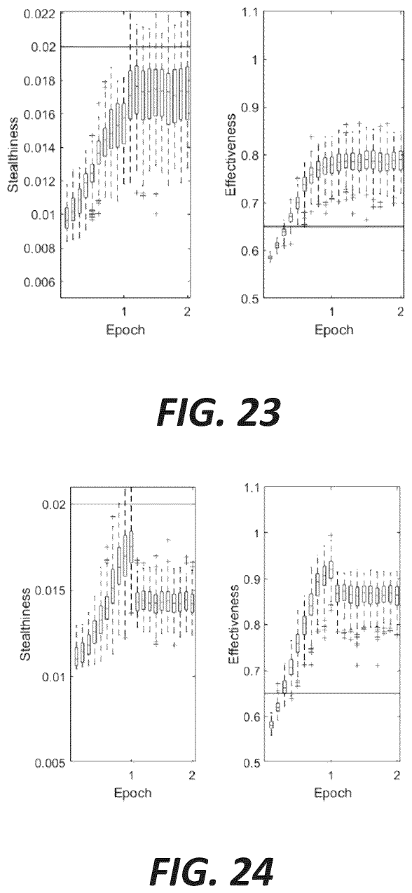

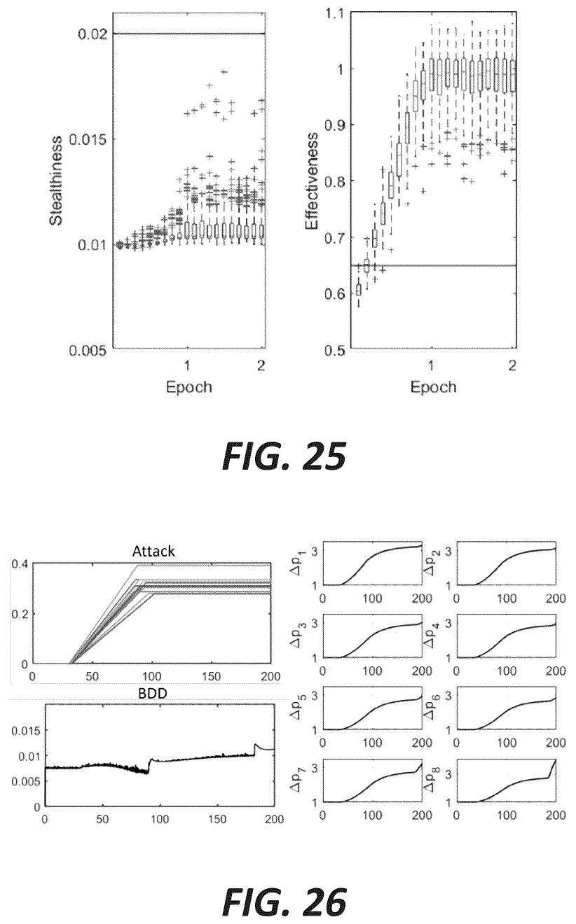

FIG. 23, FIG. 24, and FIG. 25 show the testing performance of the 180 sample generative attacks from the trained generator after each batch in the first 2 epochs, and FIG. 30 shows the testing scores of the trained generators after batches in the first 2 epochs. As shown in FIG. 23, FIG. 24, and FIG. 25, it is seen that all three generators started at a similar situation where although the generative attacks are not detectable, they are not effective enough. Thus, the generators attempted to increase the effectiveness in the first epoch, while stealthiness also increased due to the positive correlation between effectiveness and stealthiness. For the linear topological case as shown in FIG. 23, the generator converged at the second epoch since the effectiveness and stealthiness do not move anymore. However, a small portion of generative attacks is detectable. This is because the threshold setting is a little strict for this case. If a lower effectiveness threshold is given, the testing score of the generator becomes 100% after converging. For the tree topological case as shown in FIG. 24, the generator was also too aggressive to increase effectiveness, which caused the stealthiness to exceed the thresholds in the first epoch. But in the second epoch, the generator was able to lower it back and converged to the target feasible attack set. For the cyclic topological case as shown in FIG. 25, the generator could converge to the biggest effectiveness while maintaining the smallest stealthiness compared other two topological cases. This indicates the cyclic topological pipeline network used in this case study is the most vulnerable one and the linear topological pipeline network used in this case study is the most resilient one.

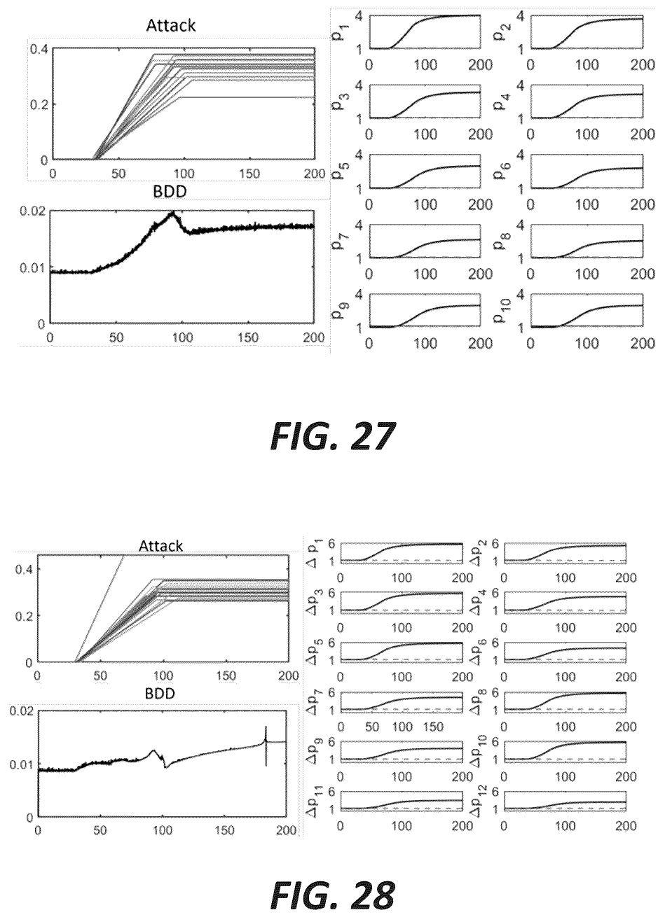

Next, the study evaluated the performance of generated feasible attacks by injecting them into the time-series simulation of those three pipeline systems. The results are presented in FIG. 26, FIG. 27, and FIG. 28. The subplots show the ratio of the attack signals e to the measurements. The attacks use Ramp attack policy injected between 0.1 Tₛᵢₘ=20 s and 0.2 Tₛᵢₘ=40 s. The subplots show the BDD output which is the estimation residual ∥y(k)−x′(k)∥₂. The subplots further show the node pressure deviation ratio from the equilibrium points. The generative attacks misled the node pressure to deviate from the target equilibrium point and arrive at a wrong equilibrium point. Comparing the performance topology-wise, it is seen that the most deviation from the nominal node pressure is aroused for the cyclic topological network. This phenomenon is consistent with the testing results shown in FIG. 23, FIG. 24, and FIG. 25. It indicates that more nodes and a more complicated network topology would provide more opportunities for the proposed attack generation framework to explore more vulnerability space.

The study developed a data-driven attack generation system accessing the vulnerability of nonlinear NCPS. It does not require the model knowledge of the system but only runtime data. The framework comprises three interactive models: two discriminative models that assess attack signals and a generative model that generates feasible attacks. To ensure a high probability of successful attack generation, the study disclosed a loss function and a training algorithm with convergence guarantee. The implementations described herein are highly versatile and can be applied to various NCPS. It can enable the learning of stealthiness boundaries while exploring effectiveness, which holds immense potential for use in resilient co-design with learning-based BDDs.

The study further contemplates that implementations of the present disclosure can automatically find an optimal attack policy using an algorithm similar to policy learning and/or include an automatic approach to identify the thresholds of effectiveness and stealthiness, ensuring that the feasible attack set is not void. Implementations of the present disclosure can include additional features not described as part of algorithm 1 shown in FIG. 3B, for example. Additionally, it should again be understood that the example applications described in the study are non-limiting examples, and that any number/type of systems can be studied using the disclosed attack generation systems.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The following patents, applications, and publications, as listed below and throughout this document, describes various application and systems that could be used in combination the exemplary system and are hereby incorporated by reference in their entirety herein
[1] A. Hobbs, “The colonial pipeline hack: Exposing vulnerabilities in us cybersecurity,” in SAGE Business Cases. SAGE Publications: SAGE Business Cases Originals, 2021.
[2] R. Langner, “Stuxnet: Dissecting a cyberwarfare weapon,” IEEE Security & Privacy, vol. 9, no. 3, pp. 49-51, 2011.
[3] F. Pasqualetti, F. Dorfler, and F. Bullo, “Attack detection and identification in cyber-physical systems,” IEEE transactions on automatic control, vol. 58, no. 11, pp. 2715-2729, 2013.
[4] G. Chen, Y. Zhang, S. Gu, and W. Hu, “Resilient state estimation and control of cyber-physical systems against false data injection attacks on both actuator and sensors,” IEEE Transactions on Control of Network Systems, vol. 9, no. 1, pp. 500-510, 2021.
[5] T. Sui, Y. Mo, D. Marelli, X. Sun, and M. Fu, “The vulnerability of cyber-physical system under stealthy attacks,” IEEE Transactions on Automatic Control, vol. 66, no. 2, pp. 637-650, 2020.
[6] X. Ren and Y. Mo, “Secure detection: Performance metric and sensor deployment strategy,” IEEE Transactions on Signal Processing, vol. 66, no. 17, pp. 4450-4460, 2018.
[7] M. H. Shahriar, A. A. Khalil, M. A. Rahman, M. H. Manshaei, and D. Chen, “iattackgen: Generative synthesis of false data injection attacks in cyber-physical systems,” in 2021 IEEE Conference on Communications and Network Security (CNS). IEEE, 2021, pp. 200208.
[8] A. Khazraei, S. Hallyburton, Q. Gao, Y. Wang, and M. Pajic, “Learning-based vulnerability analysis of cyber-physical systems,” in 2022 ACM/IEEE 13th International Conference on Cyber-Physical Systems (ICCPS). IEEE, 2022, pp. 259-269.
[9] A. N. Kolmogorov and A. T. Bharucha-Reid, Foundations of the theory of probability: Second English Edition. Courier Dover Publications, 2018.
[10] C. Godsil and G. F. Royle, Algebraic graph theory. Springer Science & Business Media, 2001, vol. 207.
[11] A. Osiadacz, Simulation and analysis of gas networks. Gulf Publishing Company, Houston, TX, 1987.
[12] H. Perez-Blanco and T. B. Henricks, “A gas turbine dynamic model for simulation and control,” in Turbo Expo: Power for Land, Sea, and Air, vol. 78637. American Society of Mechanical Engineers, 1998, p. V002T03A002.
[13] Y. Liu, P. Ning, and M. K. Reiter, “False data injection attacks against state estimation in electric power grids,” ACM Transactions on Information and System Security (TISSEC), vol. 14, no. 1, pp. 133, 2011.
[14] Y. Zheng and O. M. Anubi, “Resilient observer design for cyberphysical systems with data-driven measurement pruning,” in Security and Resilience in Cyber-Physical Systems. Switzerland: Springer, 2022, pp. 85-117.
[15] Y. Mo and B. Sinopoli, “False data injection attacks in control systems,” in Preprints of the 1st workshop on Secure Control Systems, vol. 1, 2010.
[16] S. Zhao, H. Ren, A. Yuan, J. Song, N. Goodman, and S. Ermon, “Bias and generalization in deep generative models: An empirical study,” Advances in Neural Information Processing Systems, vol. 31, 2018.
[1A] M. Dahleh, E. Frazzoli, A. Megretski, S. Ozdaglar, P. Parrilo, and D. Shah, “Information and control: a bridge between the physical and decision layers,” in NSF Workshop on CyberPhysical Systems, 2006.
[2A] Q. Zhu and L. Bushnell, “Networked cyber-physical systems: Interdependence, resilience and information exchange,” in 2013 51st Annual Allerton conference on communication, control, and computing (Allerton). IEEE, 2013, pp. 763-769.
[3A] S. Paul, Z. Ni, and C. Mu, “A learning-based solution for an adversarial repeated game in cyber-physical power systems,” IEEE Transactions on Neural Networks and Learning Systems, vol. 31, no. 11, pp. 4512-4523, 2019.
[4A] C. Spandonidis, P. Theodoropoulos, F. Giannopoulos, N. Galiatsatos, and A. Petsa, “Evaluation of deep learning approaches for oil & gas pipeline leak detection using wireless sensor networks,” Engineering Applications of Artificial Intelligence, vol. 113, p. 104890, 2022.
[5A] L. Zhang, J. Sun, and G. Orosz, “Hierarchical design of connected cruise control in the presence of information delays and uncertain vehicle dynamics,” IEEE Transactions on Control Systems Technology, vol. 26, no. 1, pp. 139-150, 2017.
[6A] P. P. Sahoo, A. Kanellopoulos, and K. G. Vamvoudakis, “Intermittent learning through operant conditioning for cyber-physical systems,” IEEE Transactions on Neural Networks and Learning Systems, 2021.
[7A] F. Pasqualetti, F. Dorfler, and F. Bullo, “Attack detection and identification in cyber-physical systems,” IEEE transactions on automatic control, vol. 58, no. 11, pp. 2715-2729, 2013.
[8A] K.-D. Lu, L. Zhou, and Z.-G. Wu, “Representation-learning-based cnn for intelligent attack localization and recovery of cyber-physical power systems,” IEEE Transactions on Neural Networks and Learning Systems, 2023.
[9A] Y. Liu, P. Ning, and M. K. Reiter, “False data injection attacks against state estimation in electric power grids,” ACM Transactions on Information and System Security (TISSEC), vol. 14, no. 1, pp. 1-33, 2011.
[10A] Y. Mo and B. Sinopoli, “False data injection attacks in control systems,” in Preprints of the 1st workshop on Secure Control Systems, vol. 1, 2010.
[11A] L. Hu, Z. Wang, Q.-L. Han, and X. Liu, “State estimation under false data injection attacks: Security analysis and system protection,” Automatica, vol. 87, pp. 176-183, 2018.
[12A] T. Sui, Y. Mo, D. Marelli, X. Sun, and M. Fu, “The vulnerability of cyber-physical system under stealthy attacks,” IEEE Transactions on Automatic Control, vol. 66, no. 2, pp. 637-650, 2020.
[13A] X. Liu, Z. Bao, D. Lu, and Z. Li, “Modeling of local false data injection attacks with reduced network information,” IEEE Transactions on Smart Grid, vol. 6, no. 4, pp. 1686-1696, 2015.
[14A] A.-Y. Lu and G.-H. Yang, “False data injection attacks against state estimation without knowledge of estimators,” IEEE Transactions on Automatic Control, 2022.
[15A] A. Khazraei, S. Hallyburton, Q. Gao, Y. Wang, and M. Pajic, “Learning-based vulnerability analysis of cyber-physical systems,” in 2022 ACM/IEEE 13th International Conference on Cyber-Physical Systems (ICCPS). IEEE, 2022, pp. 259-269.
[16A] I. L. Carreno, A. Scaglione, A. Zlotnik, D. Deka, and K. Sundar, “An adversarial model for attack vector vulnerability analysis on power and gas delivery operations,” Electric Power Systems Research, vol. 189, p. 106777, 2020.
[17A] R. Fu, X. Huang, Y. Xue, Y. Wu, Y. Tang, and D. Yue, “Security assessment for cyber physical distribution power system under intrusion attacks,” IEEE Access, vol. 7, pp. 75615-75628,2018.
[18A] K. Yan, X. Liu, Y. Lu, and F. Qin, “A cyber-physical power system risk assessment model against cyberattacks,” IEEE Systems Journal, 2022.
[19A] M. Mohammadpourfard, F. Ghanaatpishe, M. Mohammadi, S. Lakshminarayana, and M. Pechenizkiy, “Generation of false data injection attacks using conditional generative adversarial networks,” in 2020 IEEE PES Innovative Smart Grid Technologies Europe (ISGT-Europe). IEEE, 2020, pp. 41-45.
[20A] M. H. Shahriar, A. A. Khalil, M. A. Rahman, M. H. Manshaei, and D. Chen, “iattackgen: Generative synthesis of false data injection attacks in cyber-physical systems,” in 2021 IEEE Conference on Communications and Network Security (CNS). IEEE, 2021, pp. 200-208.
[21A] C. Godsil and G. F. Royle, Algebraic graph theory. Springer Science & Business Media, 2001, vol. 207.
[22A] G. F. Coulouris, J. Dollimore, and T. Kindberg, Distributed systems: concepts and design. pearson education, 2005.
[23A] J. K. Hedrick and A. Girard, “Control of nonlinear dynamic systems: Theory and applications,” Controllability and observability of Nonlinear Systems, vol. 48, pp. 133-160, 2005.
[24A] M. Pajic, J. Weimer, N. Bezzo, O. Sokolsky, G. J. Pappas, and I. Lee, “Design and implementation of attack-resilient cyberphysical systems: With a focus on attack-resilient state estimators,” IEEE Control Systems Magazine, vol. 37, no. 2, pp. 66-81, 2017.
[25A] E. D. Sontag, “A ‘universal’ construction of artstein's theorem on nonlinear stabilization,” Systems & control letters, vol. 13, no. 2, pp. 117-123, 1989.
[26A]—, Mathematical control theory: deterministic finite dimensional systems. Springer Science & Business Media, 2013, vol. 6.
[27A] B. W. Bequette, Process control: modeling, design, and simulation. Prentice Hall Professional, 2003.
[28A] Y. Zheng and O. M. Anubi, “Attack-resilient weighted l₁ observer with prior pruning,” in American Control Conference, 2021, pp. 340-345.
[29A] Y. Zheng, S. B. Mudhangulla, and O. M. Anubi, “Moving-horizon false data injection attack design against cyber-physical systems,” Control Engineering Practice, vol. 136, p. 105552, 2023.
[30A] C. Huang, J. Wen, Y. Xu, Q. Jiang, J. Yang, Y. Wang, and D. Zhang, “Self-supervised attentive generative adversarial networks for video anomaly detection,” IEEE transactions on neural networks and learning systems, 2022
[31A] K. Hornik, M. Stinchcombe, and H. White, “Multilayer feedforward networks are universal approximators,” Neural networks, vol. 2, no. 5, pp. 359-366,1989.
[32A] I. Gühring, G. Kutyniok, and P. Petersen, “Error bounds for approximations with deep relu neural networks in w s, p norms,” Analysis and Applications, vol. 18, no. 05, pp. 803-859, 2020.
[33A] K. Hornik, M. Stinchcombe, and H. White, “Universal approximation of an unknown mapping and its derivatives using multilayer feedforward networks,” Neural networks, vol. 3, no. 5, pp. 551-560, 1990.
[34A] E. Scholtz, “Observer-based monitors and distributed wave controllers for electromechanical disturbances in power systems,” Ph.D. dissertation, Massachusetts Institute of Technology, 2004.
[35A] A. Osiadacz, Simulation and analysis of gas networks. Gulf Publishing Company, Houston, TX, 1987.
[36A] H. Perez-Blanco and T. B. Henricks, “A gas turbine dynamic model for simulation and control,” in Turbo Expo: Power for Land, Sea, and Air, vol. 78637. American Society of Mechanical Engineers, 1998, p. V002T03A002.
[37A] Y. Zheng and O. M. Anubi, “Data-driven vulnerability analysis of networked pipeline system,” in 2023 IEEE Conference on Control Technology and Applications (CCTA). IEEE, 2023, pp. 1022-1027.
[38A] R. Z. Ríos-Mercado and C. Borraz-Sánchez, “Optimization problems in natural gas transportation systems: A state-of-the-art review,” Applied Energy, vol. 147, pp. 536-555, 2015.

What is claimed:

1. A computer-implemented method of training a machine learning model, the method comprising:
generating a random parameter vector;
generating a random attack dataset;
inputting a plurality of samples of the random attack dataset into a generator;
generating, by the generator, a generated attack dataset;
training a discriminator using the random attack dataset and the generated attack dataset; and
training the generator using the trained discriminators and a loss function.

2. The computer-implemented method of claim 1, wherein the generated attack dataset comprises an attack policy.

3. The computer-implemented method of claim 2, wherein the attack policy comprises a ramp attack.

4. The computer-implemented method of claim 2, wherein the attack policy comprises a sensor attack.

5. The computer-implemented method of claim 2, wherein the generator comprises a deep neural network.

6. The computer-implemented method of claim 5, wherein the generator is trained with the loss function:
$$L ( G ( z ; θ ) ) = ReLU ( {𝔼}_{z \sim {P}_{z}} [ D ( G ( z ; θ ) ) ] - ( 1 - α ) ) .$$

7. A computer-implemented method for training a machine learning model, the method comprising:
receiving a generative model parameter vector;
generating sample points from a prior distribution of the generative model parameter vector;
generating attack policy parameters
simulating simulated attack policy parameters by a system simulation
training a generative model by the simulated attack policy parameters.

8. The computer-implemented method of claim 7, wherein training the generative model comprises a deep neural network.

9. The computer-implemented method of claim 7, wherein training the generative model comprises selecting a best loss value by J_{best}⁽ⁱ⁺¹⁾=min{J_{best}⁽ⁱ⁾,J(θ_{g}⁽ⁱ⁺¹⁾)}.

10. The computer-implemented method of claim 7, wherein the attack policy parameters comprise a ramp attack policy.

11. The computer-implemented method of claim 7, wherein the attack policy parameters comprise a sine attack policy.

12. The computer-implemented method of claim 7, wherein the attack policy parameters comprise a pulse attack policy.

13. A cybersecurity system comprising:
a physical plant
a network configured for communications and/or control of the physical plant;
a cybersecurity controller operably connected to the network, wherein the cybersecurity controller comprises a processor and memory with instructions stored thereon, that, when executed by the processor cause the processor to:
receive a trained attack generative model;
simulate, by the trained attack generative model, a plurality of attacks on the physical plant;
determine an attack effectiveness of each of the plurality of attacks; and
control access to the network based on the effectiveness of each of the plurality of attacks.

14. The system of claim 13, wherein the physical plant comprises a networked pipeline system.

15. The system of claim 14, wherein the networked pipeline system comprises a plurality of pressure sensors operably coupled to the network, and controlling access to the network comprises securing at least one of the plurality of pressure sensors.

16. The system of claim 13, wherein the physical plant comprises a power grid.

17. The system of claim 16, wherein the power grid comprises a plurality of meters configured to measure the power and frequency of the power grid, and controlling access to the network comprises securing at least one of the plurality of meters.

18. The system of claim 13, wherein the physical plant comprises a cyber-physical system.

19. The system of claim 13, wherein the physical plant comprises an industrial facility.

20. The system of claim 13, wherein the controller further contains instructions that cause the processor to simulate a vulnerability of the physical plant and control the physical plant based on the vulnerability.
